(19) United States
(12) Patent Application Publication
(10) Pub. No.: US 2026/0267164 A1
(43) Pub. Date: Sep. 10, 2026

(54) OPHTHALMIC LENSES WITH LIGHT SCATTERING FOR TREATING MYOPIA AND METHODS FOR MAKING THE SAME

(71) Applicant: SIGHTGLASS VISION, INC., Dallas, TX (US)

(72) Inventors: Peter HONES, Palo Alto, CA (US); Ebrahim ABOUALIZADEH, Belmont, CA (US)

(21) Appl. No.: 19/491,350

(22) PCT Filed: Jun. 7, 2024
(86) PCT No.: PCT/US2024/033064

§ 371 Date: Dec. 8, 2025

Related U.S. Application Data
(60) Provisional application No. 63/471,953, filed on Jun. 8, 2023.

(51) Int. Cl. G02C 7/02; G02C 7/04

(52) U.S. Cl. CPC G02C 7/022; G02C 7/024; G02C 7/04; G02C 2202/24

(57) ABSTRACT

Ophthalmic lenses for reducing progression of myopia include scattering centers with reduced backscattering are disclosed, including various shapes and patterns for the scattering centers. Methods for making the ophthalmic lenses and devices incorporating the ophthalmic lenses are disclosed.

### FIELD OF THE INVENTION

The invention features ophthalmic lenses for treating myopia and reducing myopia progression and methods for making the same.

### BACKGROUND

The eye is an optical sensor in which light from external sources is focused, by a lens, onto the surface of the retina, an array of wavelength-dependent photosensors. Each of the various shapes that the eye lens can adopt is associated with a focal length at which external light rays are optimally or near-optimally focused to produce inverted images on the surface of the retina that correspond to external images observed by the eye. The eye lens, in each of the various shapes that the eye lens can adopt, optimally or near-optimally, focuses light emitted by, or reflected from external objects that lie within a certain range of distances from the eye, and less optimally focuses, or fails to focus objects that lie outside that range of distances.

In normal-sighted individuals, the axial length of the eye, or distance from the lens to the surface of the retina, corresponds to a focal length for near-optimal focusing of distant objects. The eyes of normal-sighted individuals focus distant objects without nervous input to muscles which apply forces to alter the shape of the eye lens, a process referred to as “accommodation.” Closer, nearby objects are focused, by normal individuals, as a result of accommodation.

Many people, however, suffer from eye-length-related disorders, such as myopia (“nearsightedness”). In myopic individuals, the axial length of the eye is longer than the axial length required to focus distant objects without accommodation. As a result, myopic individuals can view near objects clearly, but objects further away are blurry. While myopic individuals are generally capable of accommodation, the average distance at which they can focus objects is shorter than that for normal-sighted individuals.

Typically, infants are born hyperopic, with eye lengths shorter than needed for optimal or near optimal focusing of distant objects without accommodation. During normal development of the eye, referred to as “emmetropization,” the axial length of the eye, relative to other dimensions of the eye, increases up to a length that provides near-optimal focusing of distant objects without accommodation. Ideally, biological processes maintain the near-optimal relative eye length to eye size as the eye grows to final, adult size. However, in myopic individuals, the relative axial length of the eye to overall eye size continues to increase during development, past a length that provides near-optimal focusing of distant objects, leading to increasingly pronounced myopia.

It is believed that myopia is affected by behavioral factors as well as genetic factors. Accordingly, myopia may be mitigated by therapeutic devices which address behavioral factors. For example, therapeutic devices for treating eye-length related disorders, including myopia, are described in U.S. Pub. No. 2011/0313058A1.

### SUMMARY

Eyeglasses are disclosed that reduce signals in the retina responsible for growth of eye length. Example eyeglass lenses are made using, e.g., polycarbonate or Trivex lens blanks which have been treated by forming a pattern of scattering centers, or “dots,” optionally having an aperture free of dots on the viewing axis. The dots scatter incident light that would otherwise be focused by the lens and the result is a reduction in contrast in a retinal image. The contrast reduction reduces eye growth associated with myopia progression, especially in children. The optional aperture, free from dots, is typically located on a visual axis corresponding to the wearer's distance vision and allows a user to experience maximal visual acuity when viewing on-axis objects, while objects in the periphery of the user's visual field are viewed with reduced contrast and acuity.

Control of the dot size and shape is used to tailor the light scattering properties of the lenses. One function is to increase forward scattering into directions where the scattered light contributes to reduced image contrast in the wearer's peripheral visual field. Another function is to reduce backscattered light. Reducing backscattered light can reduce the conspicuity of a dot pattern. The increased directional forward scattering can reduce the overall number of dots needed to provide the therapeutic effect.

Laser exposure methods useful for forming dots having the desired shapes are also disclosed. The exposure methods can include using laser scanning paths that can be implemented efficiently, increasing overall throughput of a laser system by reducing exposure times or cycle times.

Among other advantages, disclosed embodiments feature eyeglasses that include features that reduce signals in the retina responsible for growth of eye length on the lenses for both eyes, without diminishing the user's on-axis vision in either eye to an extent that is disruptive to the user. For example, providing a dot pattern that modestly blurs the wearer's peripheral vision or decreases contrast while allowing normal on-axis viewing through a clear aperture allows for all-day, every-day use by the wearer. Disclosed embodiments can also provide therapeutic benefits to a user in both eyes using only a single pair of eyeglasses, in contrast to approaches which involve alternating use of different pairs of eyeglasses.

Moreover, the dot patterns can be largely unnoticeable to others, particularly where dot patterns are clear and colorless and/or where contact lenses are used. The subtlety of the dot patterns can result in more consistent use by certain wearers, especially children, who may otherwise be self-conscious during everyday (e.g., at school or otherwise among peers) use of more conspicuous devices. For example, graded dot patterns can be used to reduce conspicuity of dot patterns to third parties.

Disclosed embodiments can allow dot patterns for mitigating eye lengthening to be efficiently and economically formed on conventional ophthalmic lenses, for example by forming dot patterns on a surface or in the bulk of the lens.

### BRIEF DESCRIPTION OF THE DRAWINGS

FIG. 1A shows an example pair of eyeglasses containing ophthalmic lenses for reducing progression of myopia.

FIG. 1B shows an ophthalmic lens shown in FIG. 1A prior to edging.

FIG. 1C shows a plan view of a dot pattern in the reduced contrast region of the lens shown in FIG. 1B.

FIG. 2 is a schematic diagram showing light scattering from the ophthalmic lens shown in FIG. 1B.

FIG. 3A shows a cross-sectional view of an example dot composed of a depression in a lens surface.

FIG. 3B shows a cross-sectional view of an example dot composed of a protrusion on a lens surface.

FIG. 3C shows a cross-sectional view of another example dot composed of a depression in a lens surface.

FIG. 3D shows a cross-sectional view of a further example dot composed of a depression in a lens surface.

FIGS. 4A-4S show plan views of example dot perimeter paths.

FIG. 5A is a plot comparing the number of rays hitting the retina for five different simulated dot shapes.

FIG. 5B is a plot comparing the number of backscattered rays for the five different simulated dot shapes.

FIG. 6 is a schematic diagram of an example laser system for forming dots on a surface of a lens.

FIG. 7 is a plan view of an example laser exposure path for forming a dot.

FIG. 8 is a plan view of another example laser exposure path for forming a dot.

FIG. 9A is a top view an image of two dots formed using the path shown in FIG. 8.

FIG. 9B is a cross-sectional profile of one of the dots shown in FIG. 9A.

FIG. 10A is a top view of an image of two dots formed using the path shown in FIG. 7.

FIG. 10B is a cross-sectional profile of one of the dots shown in FIG. 10A.

FIG. 11A is a plan view of an example laser exposure path for forming a dot with discrete pulses of laser radiation along the path.

FIG. 11B is a top view of an image of two dots formed using the path shown in FIG. 11A.

FIG. 11D is a cross-sectional profile of one of the dots shown in FIG. 11B.

FIG. 12A is an example dot pattern on an ophthalmic lens with dots created by laser burn-in.

FIG. 12B is a partial, magnified view of the dot pattern of FIG. 12A.

FIG. 12C is a magnified, cross-sectional view of a dot taken at C-C of FIG. 12B.

FIG. 13 is a flow chart of a method of forming a dot using a laser system with laser burn-in for forming trenches.

FIG. 14 shows an example dot pattern with dots of different sizes.

FIG. 15 shows another example dot pattern with dots of different sizes.

FIG. 16 shows a further example dot pattern with dots of different sizes.

FIG. 17 shows an example dot pattern with overlapping dots.

FIG. 18 shows an example dot pattern with rows of overlapping dots.

FIG. 19 shows another example dot pattern with rows and columns of overlapping and non-overlapping dots.

FIG. 20 shows another example dot pattern with radial arrays of overlapping dots of varying sizes.

FIG. 21 shows another example dot pattern with radial arrays and overlapping and non-overlapping dots of varying sizes.

FIG. 22 shows another example dot pattern with overlapping and non-overlapping dots of varying sizes.

In the drawings, like reference numbers denote like elements.

### DETAILED DESCRIPTION

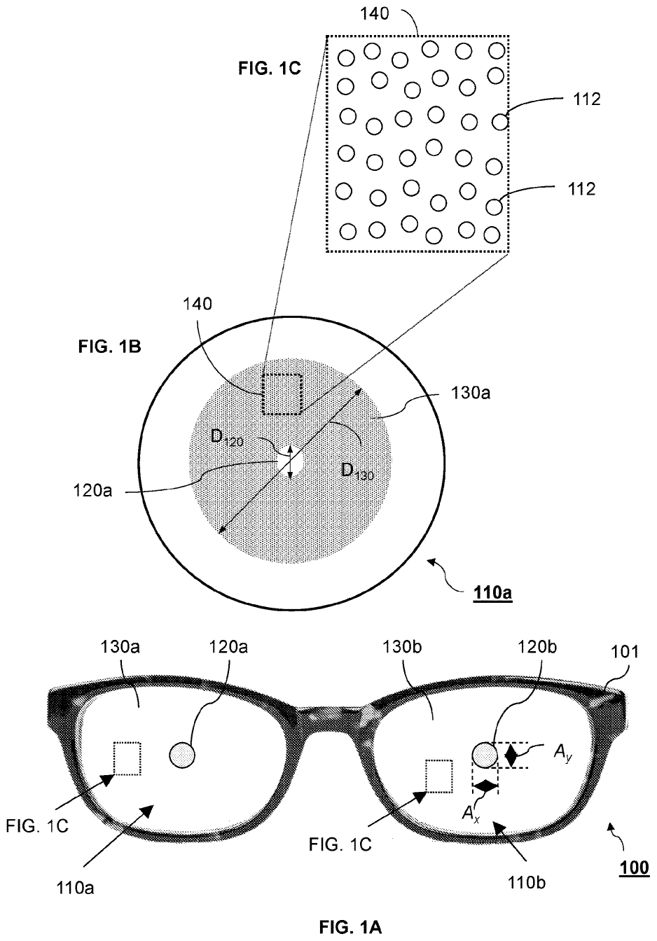

Referring to FIGS. 1A-1C, eyeglasses 100 for reducing myopia progression shown. The eyeglasses 100 treat both eyes simultaneously without substantially compromising clear vision on axis for the wearer. Moreover, the eyeglasses are sufficiently robust and inconspicuous as to allow a wearer to engage in the same day-to-day activities without the eyeglasses failing and without feeling self-conscious about their appearance, which is especially desirable because the eyeglasses are typically used to arrest eye-lengthening in children.

The eyeglasses 100 are composed of a pair of frames 101 and ophthalmic lenses 110a and 110b mounted in the frames 101. Generally, the ophthalmic lenses can be plano lenses, single vision lenses (e.g., with positive or negative power) or multivision lenses (e.g., bifocals or progressive lenses). The ophthalmic lenses 110a and 110b each have a clear aperture 120a and 120b, respectively, surrounded by reduced contrast areas 130a and 130b, respectively. Clear apertures 120a and 120b can be positioned to coincide with the wearer's distance vision, while reduced contrast areas 130a and 130b correspond to the wearer's peripheral visual field while the wearer's gaze direction corresponds to distance vision. Lens 110a is shown pre-edged in FIG. 1B.

In general, the size and shape of the clear apertures 120a and 120b may vary. Generally, the clear aperture provides the wearer with a viewing cone for which their visual acuity may be optimally corrected (e.g., to 20/15 or 20/20 ). In some examples, the aperture has a maximum dimension in a range from about 0.2 mm (e.g., about 0.3 mm or more, about 0.4 mm or more, about 0.5 mm or more, about 0.6 mm or more, about 0.7 mm or more, about 0.8 mm or more, about 0.9 mm or more) to about 1.5 cm (e.g., about 1.4 cm or less, about 1.3 cm or less, about 1.2 cm or less, about 1.1 cm or less, about 1 cm or less). Where the aperture is circular, e.g., as depicted in FIGS. 1A and 1B, this dimension corresponds to the circle's diameter D120, however non-circular (e.g., elliptical, polygonal, tear shaped) apertures are also possible.

The clear aperture can subtend a solid angle of about 30 degrees or less (e.g., about 25 degrees or less, about 20 degrees or less, about 15 degrees or less, about 12 degrees or less, about 10 degrees or less, about 9 degrees or less, about 8 degrees or less, about 7 degrees or less, about 6 degrees or less, about 5 degrees or less, about 4 degrees or less, about 3 degrees or less) in the viewer's visual field. The solid angles subtended in the horizontal and vertical viewing planes may be the same or different.

In some cases, lenses 110a and 110b can include no clear aperture and the reduced contrast areas occupy the entire on-axis visual field.

Referring to FIG. 1B, reduced contrast area 130a extends to a radius that is less than the pre-edged lens radius, occupying an annular area surrounding clear aperture 120a. Generally, the reduced contrast area of the pre-edged lens extends sufficiently far so that, after edging the lens and mounting it in frames 101, a desired level of light scattering is achieved for the user's peripheral field of view regardless of the viewing direction while the user is wearing eyeglasses. The reduced contrast area 130a can have a maximum dimension (e.g., diameter D130 in the case of a circular area) in a range from about 3 cm to about 9 cm (e.g., about 4 cm or more, about 5 cm or more, about 6 cm or more, about 7 cm or more, such as about 8 cm or less). While reduced contrast area 130a has a circular perimeter, other shapes are possible (e.g., elliptical, polygonal, etc.).

Referring particularly to FIG. 1C, reduced contrast areas 130a and 130b include scattering centers, also referred to as “dots” 112, which reduce the contrast of an object in the wearer's peripheral vision by scattering light passing through those areas to the wearer's eye. The lens area between dots 140 corresponds to the original (e.g., Rx) lens surface which provides a clear, focused image for the wearer. The result of the reduced contrast area 130 is to provide a resolvable image for the wearer, corrected for any refractive error for the wearer, with a contrast level that is reduced compared to on-axis images viewed through the clear apertures 120a and 120b.

In general, the reduced contrast region of a lens includes hundreds, or thousands of dots and the dimension of the dots may be the same across each lens or may vary. For example, the dimension may increase or decrease as a function of the location of the dot, e.g., as measured from the clear aperture and/or as a function of distance from an edge of the lens. In some examples, the dots' dimensions vary monotonically as the distance from the center of the lens increases (e.g., monotonically increase or monotonically decrease). In some cases, monotonic increasing/decreasing in dimension includes varying the diameter of the protuberances linearly as a function of the distance from the center of the lens.

The dots shown in FIG. 1C are arranged irregularly on the lens surface. In general, the dots are arranged so that, collectively, they provide sufficient contrast reduction in the viewer's periphery for myopia reduction. Typically, smaller dot spacing will result in greater contrast reduction. Generally, dots can be spaced from one another or can overlap. For spaced apart dots, the distance between adjacent dots can be 0.05 mm (e.g., about 0.1 mm or more, about 0.15 mm or more, about 0.2 mm or more, about 0.25 mm or more, about 0.3 mm or more, about 0.35 mm or more, about 0.4 mm or more, about 0.45 mm or more, about 0.5 mm or more, about 0.55 mm or more, about 0.6 mm or more, about 0.65 mm or more, about 0.7 mm or more, about 0.75 mm or more) to about 2 mm (e.g., about 1.9 mm or less, about 1.8 mm or less, about 1.7 mm or less, about 1.6 mm or less, about 1.5 mm or less, about 1.4 mm or less, about 1.3 mm or less, about 1.2 mm or less, about 1.1 mm or less, about 1 mm or less, about 0.9 mm or less, about 0.8 mm or less).

In general, the coverage of a lens by dots can vary as desired. Here, coverage refers to the proportion of the lens's total area, as projected onto the x-y plane that corresponds to a dot. Typically, a lower dot coverage will yield lower scattering than higher dot coverage (assuming individual dots are discrete, i.e., the dots do not merger to form larger dots). Dot coverage can vary from 10% or more to about 75%. For example, dot coverage can be 15% or more, 20% or more, 25% or more, 30% or more, 35% or more, 40% or more, 45% or more, such as 50% or 55%). Dot coverage can be selected according to a comfort level of a user, e.g., to provide a level of peripheral vision sufficiently comfortable that the wearer will voluntarily wear the eyeglasses for extended periods (e.g., all day).

It is believed that light from a scene that is incident on the lenses in reduced contrast areas 130a and 130b between the dots contributes to an image of the scene on the user's retina, while light from the scene incident on the dots does not. Moreover, the light incident on the dots is still transmitted to the retina, so the reduced contrast areas 130a and 130b have the effect of reducing image contrast without substantially reducing light intensity at the retina. Accordingly, it is believed that the amount of contrast reduction in the user's peripheral field of view is correlated to (e.g., is approximately proportional to) the proportion of the surface area of the reduced-contrast areas covered by the dots. Generally, dots occupy at least 10% (e.g., 20% or more, 30% or more, 40% or more, 50% or more, such as 90% or less, 80% or less, 70% or less, 60% or less) of the area (as measured in the x-y plane) of reduced contrast area 130a and 130b.

In general, the dot pattern reduces the contrast of images of objects in the wearer's peripheral vision without significantly degrading the viewer's visual acuity in this region. Here, peripheral vision refers to the field of vision outside of the field of the clear aperture. Image contrast in these regions can be reduced by 40% or more (e.g., 45% or more, 50% or more, 60% or more, 70% or, more, 80% or more) relative to an image contrast viewed using the clear aperture of the lens as determined. Contrast reduction may be set according to the needs of each individual case. It is believed that a typical contrast reduction would be in a range from about 50% to 55%. Contrast reductions of lower than 50% may be used for very mild cases, while subjects who are more predisposed might need a higher than 55% contrast reduction. Peripheral visual acuity can be corrected to 20/30 or better (e.g., 20/25 or better, 20/20 or better) as determined by subjective refraction, while still achieving meaningful contrast reduction.

Contrast, here, refers to the difference in luminance between two objects within the same field of view. Accordingly, contrast reduction refers to a change in this difference.

Contrast and contrast reduction may be measured in a variety of ways. In some embodiments, contrast can be measured based on a brightness difference between different portions of a standard pattern, such as a checkerboard of black and white squares, obtained through the clear aperture and dot pattern of the lens under controlled conditions.

Alternatively, or additionally, contrast reduction may be determined based on the optical transfer function (OTF) of the lens (see, e.g., http://www.montana.edu/jshaw/documents/18%20EELE582_S15_OTFMTF.pdf). For an OTF, contrast is specified for transmission of stimuli in which light and dark regions are sinusoidally modulated at different “spatial frequencies.” These stimuli look like alternating light and dark bars with the spacing between bars varying over a range. For all optical systems the transmission of contrast is lowest for the sinusoidally varying stimuli having the highest spatial frequencies. The relationship describing the transmission of contrast for all spatial frequencies is the OTF. The OTF can be obtained by taking the Fourier transform of the point spread function. The point spread function can be obtained by imaging a point source of light through the lens on to a detector array and determining how light from a point is distributed across the detector.

In the event of conflicting measurements, the OTF is technique is preferred.

In some embodiments, contrast may be estimated based on the ratio of the area of the lens covered by dots compared to the area of the clear aperture. In this approximation, it is assumed that all the light that hits the dots becomes uniformly dispersed across the entire retinal area, which reduces the amount of light available in lighter areas of an image and this adds light to darker areas. Accordingly, contrast reduction may be calculated based on light transmission measurements made through the clear aperture and dot pattern of a lens.

Contrast may also be measured clinically by measuring changes in performance for observers wearing the lenses on visual acuity (such as a Snellen or ETDRS letter chart) and/or contrast sensitivity tests (such as a Pelli Robson chart). Contrast changes may be less than 1 line (i.e., 5 letters) of vision, approximately 0.5 lines, 1 line, 2 lines, or 3 lines or more. This can also be measured in LogMAR units of less than 0.05, or approximately 0.05, 0.10, 0.20, or 0.30 or more.

As noted previously, in general, the size, spacing, and arrangement of the dot pattern can vary. In some embodiments, the dot pattern features a gradient in, e.g., dot size and/or spacing. Dot patterns can feature a gradient in scattering efficiency of the dots (e.g., due to a gradient in the refractive index mismatch and/or shape of each dot). Graded dot patterns can reduce the conspicuity of the pattern. For example, a graded transition from the clear portions of the lens to the scattering portion can be less conspicuous than a sharp transition.

Lenses 110a and 110b can be formed from stock lenses. The lenses can be formed from conventional ophthalmic lens materials, such as polycarbonate or trivex®. The lenses can include one or more coatings or other surface treatments including, for examples, hardcoats, photochromic coatings, blue filters, anti-reflection coatings, etc.

Generally, ophthalmic lenses 110a and 110b can be clear or tinted. That is, the lenses may be optically transparent to all visible wavelengths, appearing clear and/or colorless, or may include a spectral filter, appearing colored. For example, ophthalmic lenses may include a filter that reduces the amount of red light transmitted to the wearer. It is believed that excessive stimulation of L cones in a person's eye (especially in children), may result in non-optimal eye lengthening and myopia. Accordingly, spectrally filtering red light using the ophthalmic lenses may further reduce myopia in a wearer.

In general, the dots 112 can be provided as protuberances and/or recesses on one or both surfaces of each lens, and/or as scattering inclusions in the lens material itself. In some examples, the dots can be formed by arrays of protuberances on a surface (e.g., the back surface or the front surface) of each of lenses 110a and 110b.

The protuberances can be formed from an optically transparent material having a similar refractive index to the underlying lens, which is 1.60 for polycarbonate (PC). For example, in embodiments where the lenses are formed from polycarbonate, the protuberances can be formed from a polymer having a similar refractive index to the PC, such as from light-activated polyurethane or epoxy-based plastics. In addition to PC, the lenses themselves can also be made from allyl diglycol carbonate plastic, a urethane-based monomer or other impact resistant monomers. Alternatively, lenses could be made from one of the more-dense high-refractive index plastics with an index of refraction greater than 1.60. In some embodiments, the lenses are made from optically transparent materials with lower index of refraction (e.g., CR39 is at 1.50, Trivex is at 1.53).

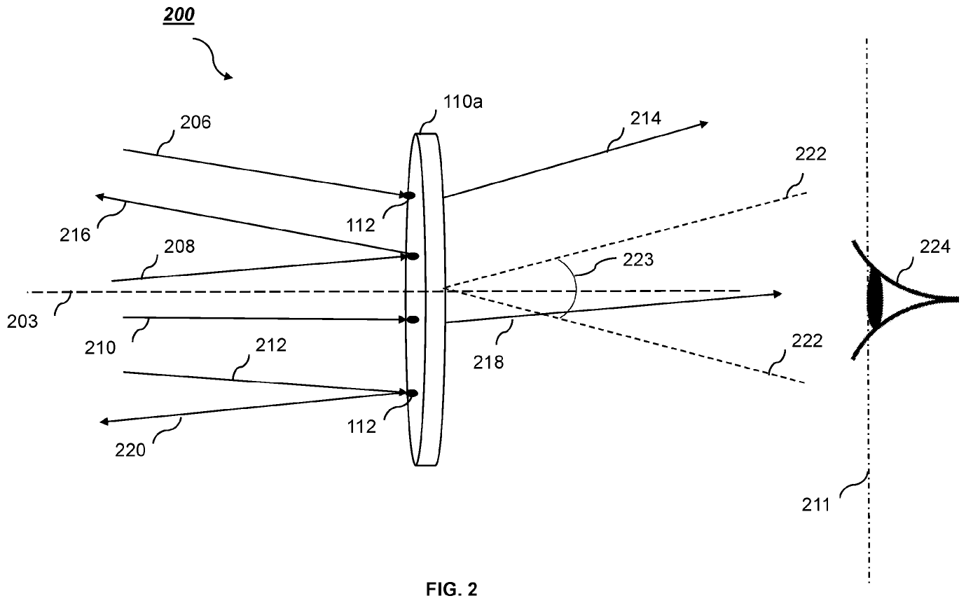

Each dot 112 is sized and shaped to scatter light incident on the dot. Generally, the dot forward scatters a portion of the incident light and back scatters a portion. Forward scattered light generally exits the lens through the opposite side from which the light is incident, while backscattered light scatters away from the lens on the side from which the light is incident. This light scattering is illustrated in FIG. 2, which shows lens 110a with scattering centers, e.g., dot 112, on the front surface of the lens. A lens axis 203 is shown for reference, e.g., corresponding to a rotational symmetry axis of the lens where the lens corrects for spherical aberrations only.

Four incident light rays 206, 208, 210, and 212, each incident on a different dot 112, are shown. Depending on the light ray's angle of incidence and the shape of the dot, the light can be forward scattered (rays 214 and 218) and/or backscattered (rays 216 and 220). Depending on the forward scattering angle and the wearer's visual axis at the time, forward scattered light entering the eye 224 can be incident on or away from the wearer's fovea or can be directed away from the retina entirely. Generally, scattered light—unlike other light focused by the lens—will not be imaged at the wearer's retina. Scattered light incident on the wearer's fovea does not necessarily reduce contrast of the wearer's foveal vision, which can be undesirable. Scattered light incident on the retina away from the fovea can reduce contrast of the wearer's peripherical visual field, reducing myopia progression as discussed previously. This forward scattered light can be considered “therapeutic light”. In some (but not all) cases, other forward scattered light, e.g., that is either incident on the fovea or outside the peripheral visual field of the retina, is not considered therapeutic. Accordingly, it can be desirable to forward scatter light along directions that will contribute to peripheral visual contrast reduction but not to foveal contrast reduction. Alternatively, in certain cases, forward scattered light that contributes to foveal contrast reduction can be acceptable.

Generally, light that is scattered into a cone that contributes to contrast reduction of images in the peripheral visual field is considered narrow-angle forward scattered light, while light outside this cone is considered to be wide-angle forward scattered light. A solid angle, depicted by outline 222 of a cone with cone angle 223 in FIG. 2, can be useful to distinguish narrow-angle scattering from wide-angle scattering. Light scattered within the cone, e.g., ray 218, is narrow-angle forward scattered light, while light scattered outside the cone, e.g., ray 214, is wide-angle scattering. The cone angle can be for narrow-angle scattering can be in a range from 1 degree to 5 degrees. In some examples, the cone angle for narrow-angle scattering can be 2.5 degrees.

Some of the incident rays are backward scattered, e.g., incident rays 208 and 212 backward scatter, becoming backward scattered rays 216 and 220. Backscattered light can be viewed by people other than the wearer, making the dots conspicuous to people looking at the wearer. Accordingly, it can be desirable to reduce (e.g., minimize the amount of backscattered light while increasing (e.g., maximizing) the amount of forward scattered light into the narrow-angles, up to a threshold amount of peripheral image contrast reduction sufficient to have the therapeutic effect describe above.

For light incident on a reduced contrast area, the amount of scattered light that is forward scattered and/or back scattered can be measured using a scanning scatterometer. A scanning scatterometer is an instrument that has a light source, such as a laser, and a detector, such as a single pixel detector. The sample is illuminated by a collimated beam from the light source, and the detector is scanned over the sphere around the sample to generate a map of where the light goes. Using this method, the total amount of light incident on the reduced contrast area that is backscattered can be 12% or less, 10% or less, 9% or less, 8% or less, 7% or less, 6% or less, 5% or less, 4% or less, 3% or less, 2% or less, 1% or less. The percentage of scattered light that is backscattered may be 50% or less, 40% or less, 30% or less, 20% or less, 10% or less, or less than 10%, such as 9% or less, 8% or less, 7% or less, 6% or less, 5% or less, 4% or less, 3% or less, 2% or less, such as 1%. The percentage of scattered light that is forward scattered may be 50% or more, 60% or more, 70% or more, 80% or more, 90% or more, 91% or more, 92% or more, 93% or more, 94% or more, 95% or more, 96% or more, 97% or more, 98% or more, such as 99%. The percentage of forward scattered light that is scattered into the narrow angle scattering directions (discussed above) can be 50% or more, 60% or more, 70% or more, 80% or more, 90% or more, such as 95%.

In some cases, the amount of light that is forward scattered and/or back scattered can be determined by optical computer simulations using, e.g., commercially available optical design software such as Zemax (from AnSys) or Code V (from Synopsys). Using this method, the total amount of light incident on the reduced contrast area that is backscattered can be 12% or less, 10% or less, 9% or less, 8% or less, 7% or less, 6% or less, 5% or less, 4% or less, 3% or less, 2% or less, 1% or less. The percentage of scattered light that is backscattered may be 50% or less, 40% or less, 30% or less, 20% or less, 10% or less, or less than 10%, such as 9% or less, 8% or less, 7% or less, 6% or less, 5% or less, 4% or less, 3% or less, 2% or less, such as 1%. The percentage of scattered light that is forward scattered may be 50% or more, 60% or more, 70% or more, 80% or more, 90% or more, 91% or more, 92% or more, 93% or more, 94% or more, 95% or more, 96% or more, 97% or more, 98% or more, such as 99%.

Thus, in general, the dot patterns in reduced contrast areas 130a and 130b and the shape of each dot is selected based on a variety of design parameters to provide a desired degree of light scattering to provide an optimal therapeutic effect while minimizing the amount of backscattered light. Generally, these design parameters include the dot pattern (i.e., dot density, dot density distribution, relative position of dots, etc.), their size and shape, their refractive index, and other properties such as the transmission and reflection properties of the dot across various wavelengths, for example. Ideally, the dot patterns are selected to provide high visual acuity on the fovea and reduced image contrast on other parts of the retina with sufficiently low discomfort to the wearer to allow for extended, continuous wear. For instance, it can be desirable for children to be comfortable wearing the eyeglasses for most, if not all, of a day. Dot size, shape and dot patterns can also be selected to provide relatively low amounts of backscattered light.

Examples of dot patterns are described in US20190033619A1 entitled “Ophthalmic lenses for treating myopia,” US20190235279A1 entitled “Ophthalmic lenses with light scattering for treating myopia,” the entire contents each of which are incorporated herein in their entirety. Further examples of dot patterns are described below.

A variety of different metrics can be used to evaluate the performance of dot patterns in order to optimize them for use in myopia reducing eyeglasses. For example, dot patterns can be optimized empirically, e.g., based on physical measurements of lenses with different dot patterns. For example, light scattering can be characterized based on haze measurements, such as international test standards for haze (e.g., ASTM D1003 and BS EN ISO 13468). Conventional hazemeters can be used, e.g., a BYK-Gardner haze meter (such as the Haze-Gard Plus instrument) that measures how much light is totally transmitted through a lens, the amount of light transmitted undisturbed (e.g., within 0.5 degree), how much is deflected more than 2.5 degrees, and clarity (amount within 2.5 degrees). Other equipment can also be used to characterize light scattering for purposes of empirically optimizing scattering patterns. For example, equipment which measures light diffusion by measuring light in annular ring around 2.5 degrees can be used (e.g., equipment from Hornell).

Alternatively, or additionally, dot patterns can be optimized by computer modelling software (e.g., Zemax or Code V).

Alternatively, or additionally, dot patterns can be optimized empirically, by designing various patterns and measuring forward scatter and backscatter using the methods described above.

In some examples, dot shapes and dot patterns can be designed based on optimization of a point spread function, which is a representation of an image of the scattering center on the retina. For example, the size, shape, and spacing of the scattering centers can be varied to evenly spread illumination of retina such that the retina outside of fovea is homogeneously blanketed with scattered light to reduce (e.g., minimize) contrast at this region of the retina.

Alternatively, or additionally, dot shapes and dot patterns can be designed based on optimization of a modulation transfer function, which refers to the spatial frequency response of the human visual system. For instance, the size, shape, and spacing of the scattering centers can be varied to smoothen attenuation of a range of spatial frequencies. Design parameters of the dot pattern can be varied to increase or decrease certain spatial frequencies as desired. Generally, the spatial frequencies of interest for vision are 18 cycles per deg. on the fine side, and 1.5 cycles per deg. on the course side. Dot patterns can be designed to provide increased signal at certain subsets of spatial frequencies within this range.

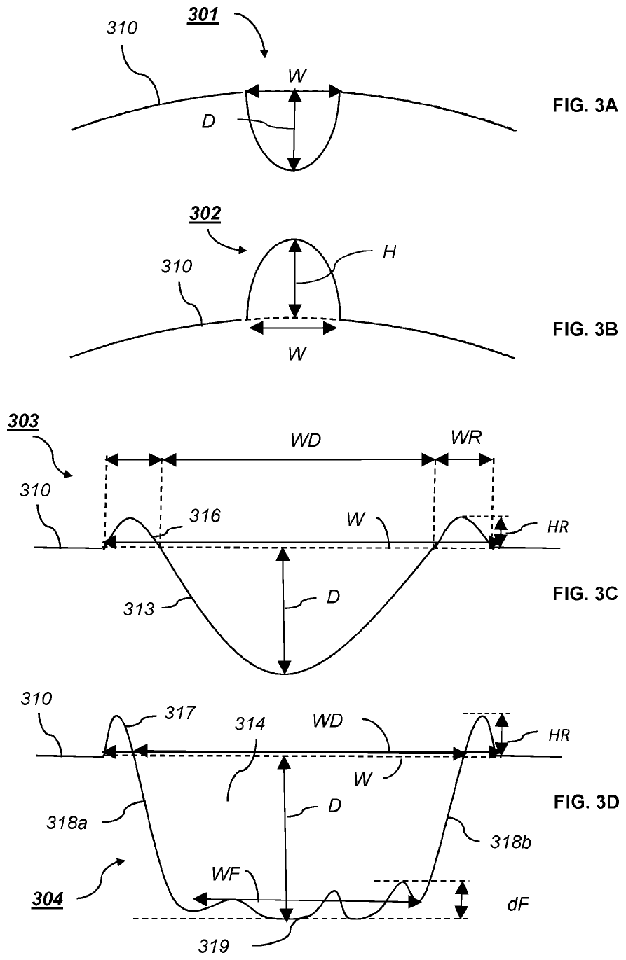

As noted above, dots can be provided either on one or both surfaces of the lens, or within the lens itself. For dots formed on a lens surface, the dot can be formed as a protrusion from the lens surface or a depression in the surface. Examples of a depression and a protrusion are shown in FIGS. 3A and 3B, respectively. In FIG. 3A, a dot 301 is formed as a depression in a lens surface 310. In a cross-sectional profile, the shape of dot 301 is characterized by a width, or lateral dimension, W, and a depth, D. The width refers to the lateral dimension from one edge of the dot (i.e., where the dot meets the lens surface) to the opposite edge. The depth refers to the vertical dimension of the dot measured from the edge of the dot to the base of the dot. Here, the depression has a parabolic profile, symmetric about a central, vertical axis that corresponds to the surface normal of lens surface 310 at the center of the dot. The profile of the dot can be the same in other cross-sections (e.g., for a dot with a circular perimeter shape) or can vary for different cross-sections. Examples of dot perimeters shapes are discussed below.

Generally, the width and depth and shape can vary as desired. As discussed further below, the width and depth can affect how the dot scatters light. In some examples, the dot has a width (e.g., a maximum width where the width varies depending on the cross-section) in a range from 10 μm to 2,000 μm (e.g., 50 μm or more, 100 μm or more, 150 μm or more, 200 μm or more, 250 μm or more, 300 μm or more, 350 μm or more, 400 μm or more, 450 μm or more, 500 μm or more, 600 μm or more, 700 μm or more, 800 μm or more, 900 μm or more, and such as 1,750 μm or less, 1,500 μm or less, 1,250 μm or less, 1,000 μm or less, 900 μm or less, 800 μm or less, 700 μm or less, 600 μm or less, 500 μm or less, such as in a range from 100 μm to 400 μm, 200 μm to 350 μm). The dot 301 can have a depth in a range from 2 μm to 500 μm (e.g., 5 μm or more, 10 μm or more, 20 μm or more, 30 μm or more, 40 μm or more, 50 μm or more, 60 μm or more, 70 μm or more, 80 μm or more, 90 μm or more, 100 μm or more, 110 μm or more, 120 μm or more, 130 μm or more, 140 μm or more, 150 μm or more, 175 μm or more, 200 μm or more, and such as 450 μm or less, 400 μm or less, 350 μm or less, 300 μm or less, 250 μm or less, 200 μm or less, 150 μm or less, 120 μm or less, 100 μm or less, 50 μm or less, 30 μm or less, 20 μm or less, such as in a range from 10 μm to 150 μm, such as in a range from 20 μm to 100 μm, such as in a range from 30 μm to 80 μm).

The depth of a depression can be less than the width. For example, the ratio D/W can be in a range from 1/50 to 9/10 (e.g., 1/40 or more, 1/30 or more, 1/20 or more, 1/10 or more, ⅕ or more, ¼ or more, ⅓ or more, ½ or more, and such as ⅘ or less, 7/10 or less, ⅗ or less, ½ or less, ⅓ or less, ¼ or less).

In certain examples, the depth is 20 μm or less, and the width (e.g., maximum width) is 100 μm or more.

It is believed that dots that have a depth less than their width, e.g., D/W as described above, can have reduced back scattering compared to dots having their depth similar to or greater than their width. Reduced backscattering can be associated with shallower dots generally, (e.g., dots with a depth of 50 μm or less). Without wishing to be bound by theory, reduced backscattering can be due to fewer ray paths including multiple reflections that are more likely when the depth or aspect ratio of the dot increases.

FIG. 3B shows a dot formed as a protrusion 302 which has a width, W, and a height (e.g., maximum height), H. The range of widths for protrusion 302 can be the same as for depression of dot 301. The range of heights can be the same as the range of depths, D, for depression of dot 301. Similar to the depression of dot 301, the higher the aspect ratio H/W of the protrusion 302, the higher the rate of backscattering as opposed to forward scattering.

While the profile of the dot 132 and the dot 134 are parabolic in the cross-sections depicted in FIGS. 3A and 3B, respectively, dots can have other profile shapes. For example, in some cases, dots are crater shaped, having a central depression that extends to a depth below the lens surface surrounded by a rim 316 that extends to a height above the lens surface. An example of a crater-shaped dot 303 is shown in FIG. 3C. The dot 303 has a width, W, and a depth, D, defined as above. In addition, depression 313 has a width WD less than the width W of the entire dot 303. The rim 316 has a height (e.g., maximum height where the height varies around the perimeter), HR, and a width (e.g., maximum width where the width varies around the perimeter), WR. W and D can be in ranges as described above. WD can be 1,500 μm or less (e.g., 1,000 μm or less, 800 μm or less, 700 μm or less, 600 μm or less, 500 μm or less, 400 μm or less, 300 μm or less, 250 μm or less, 200 μm or less, 150 μm or less, and such as 50 μm or more, 75 μm or more, 100 μm or more, 120 μm or more, 150 μm or more, 200 μm or more).

HR can be less than D. For example, HR can be D/2 or less (e.g., D/3 or less, D/4 or less, D/5 or less, D/6 or less, D/8 or less, D/10 or less). In some cases, HR is 20 μm or less (e.g., 15 μm or less, 12 μm or less, 10 μm or less, 8 μm or less, 5 μm or less, 3 μm or less, 2 μm or less).

WR can be 20 μm or less (e.g., 15 μm or less, 12 μm or less, 10 μm or less, 8 μm or less, 5 μm or less, 3 μm or less, 2 μm or less).

Dots can have irregular surfaces. An example of a dot in the form of a crater 304 with an irregular surface is shown in FIG. 3D. Here, crater 304 has a depth D and a width W defined as before. The rim 317 has a height HR and width as described above. In addition, the central depression 314 features sidewalls 318a and 318b and a floor 319. The floor 319 extends over a width, WF, and features an irregular surface which has a height variation, dF. Here, WF is measured from the base of one sidewall 318a to the base of the opposite sidewall 318b. The base of the sidewall can be identified as the location of a local minimum in the cross-sectional surface profile of a depression where the height of the floor begins to increase.

Where the sidewalls are vertical, WD=WF. Typically, WD will be the same as or larger than WF. For example, WF can be 0.95 WD or less (e.g., 0.9 WD or less, 0.8 WD or less, 0.75 WD or less, 0.7 WD or less, 0.65 WD or less, 0.6 WD or less, 0.55 WD or less, 0.5 WD or less, 0.45 WD or less, 0.4 WD or less). In some examples, WF is 500 μm or less (e.g., 400 μm or less, 300 μm or less, 250 μm or less, 200 μm or less, 150 μm or less, 100 μm or less, 80 μm or less, such as about 20 μm or more, 50 μm or more, 75 μm or more, 100 μm or more).

In some cases, a small value for dF corresponds to a smooth and flat floor 319. In examples, dF can be 0.5 D or less (e.g., 0.4 D or less, 0.3 D or less, 0.2 D or less, 0.15 D or less, 0.1 D or less, 0.075D or less, 0.05 D or less). dF can be 50 μm or less (e.g., 40 μm or less, 30 μm or less, 20 μm or less, 10 μm or less, 5 μm or less, 3 μm or less, 2 μm or less, such as 1 μm or more, 2 μm or more, 3 μm or more, 5 μm or more, 8 μm or more, 10 μm or more).

In some examples, WF is 0.5 W or more and dF is 0.2 D or less.

Without wishing to be bound by theory, it is believed that a dot with relatively steep sidewalls (e.g., where WD is not much larger than WF), that is relatively shallow (e.g., D is 50 mm or less), and with a relatively flat floor (e.g., dF is 0.2 D or less), can have relatively low amounts of backscattered light and can preferably forward scatter light into relatively narrow angles. Accordingly, such dots can provide lenses with reduced conspicuity and high treatment efficacy.

In general, the shape of a dot formed in a lens surface such as those described above can be determined using conventional surface measuring techniques, e.g., SEM microscopy, optical interferometry, etc., and conventional image analysis techniques for extracting dimensions from images acquired using the measurement techniques.

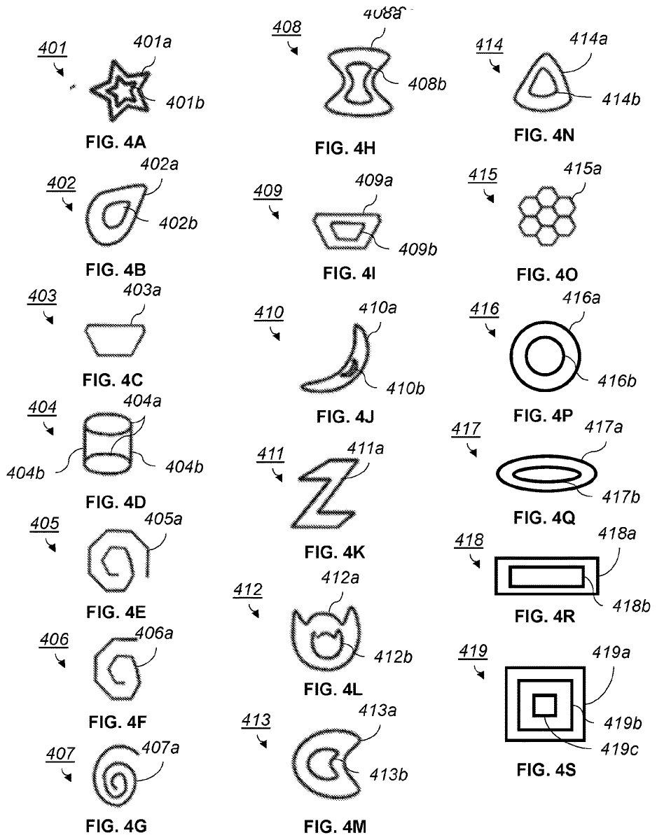

As noted previously, dot shape for surface dots is defined by the shape of the perimeter in addition to the cross-sectional profile(s). In general, dots can be formed with any perimeter shape subject to the resolution of the method used to form the dot. Generally, where a dot is formed using a method that involves depositing, removing, or modifying a material at the surface of the lens, the dot can be formed by scanning a dot forming apparatus, such as a laser (examples discussed below) along a path to alter the lens surface at that location and trace out the dot shape in the lens surface. A variety of path shapes for forming different dot perimeters are shown in FIGS. 4A-4S. Depending on the resolution of the dot forming apparatus and the size (e.g., width, as discussed previously) of the dot, the dot forming apparatus can be scanned along multiple paths, one within the other, to modify the lens surface of the entire dot.

In a first example in FIG. 4A, a dot 401 has a five-pointed star perimeter shape. The dot is formed by scanning the apparatus along the first star-shaped path 401a and the second star-shaped path 401b, interior to the path 401a and concentric with the path 401b. Each of the paths 401a and 401b can correspond to a rim as described in relation to FIG. 3D.

FIG. 4B shows a pear-shaped dot 402 formed by tracing the dot forming apparatus along a first path 402a and a second path 402b within the first path 402a. The shapes of the first and second paths 402a and 402b can be substantially the same, with the second path 402b being reduced in size. Each of paths 402a and 402b include regions with sharp and smooth turns.

FIG. 4C shows a generally trapezoidal shaped dot 403 formed by a single path 403a. The path 403a includes relatively small segments compared to the rest of the segments forming the trapezoidal shape at upper sides of the path 403a.

FIG. 4D shows a dot 404 path formed by tracing the lens forming apparatus along two elliptical paths 404a and two straight lines 404b. The paths 404a are smooth and curved, and the lines 404b are linear.

FIG. 4E shows an example of an octagonal-shaped dot 405 formed by scanning the dot forming apparatus along a continuous segmented spiral path 405a. Since the beam following the path 405a has a finite width, the resulting dot 405 can be a depression within the other part of the path 405a with an irregular depth.

FIG. 4F shows another example of a polygonal dot formed by scanning the dot forming apparatus along a continuous segmented spiral path 406a. Compared to path 405a, there are fewer linear segments in path 406a, and the outline of dot 406 will differ from that of dot 405.

FIG. 4G shows an example of an approximately circular dot 407 formed by scanning the dot forming apparatus along a continuous spiral path 407a. Compared to paths 405a and 406a, path 407a is smooth.

FIG. 4H shows a dumbbell shaped dot 408 formed by tracing the dot forming apparatus along a first path 408a and a second path 408b within the first path 408a. Although both paths 408a and 408b are dumbbell shaped, the two paths can have different parameters, e.g., aspect ratios.

FIG. 4I shows a trapezoidal shaped dot 409 formed by tracing the dot forming apparatus along a first path 409a and a second path 409b within the first path 409a. Each of paths 409a and 409b are similar to path 403a.

FIG. 4J shows a crescent shaped dot 410 formed by tracing the dot forming apparatus along a first path 410a and a second path 410b within the first path 410a. Since the path 410a is relatively narrow, e.g., has a high aspect ratio, the path 410b can be much shorter than the path 410a while still maintaining a relatively even floor.

FIG. 4K shows a zig-zag shaped dot 411 formed by tracing the dot forming apparatus along a single closed path 411a. The path 411a generally includes linear segments meeting at various angles.

FIG. 4L shows a cat head shaped dot 412 formed by tracing the dot forming apparatus along a first path 412a and a second path 412b within the first path 412a. By a beam following the path 412b within path 412a, the overall depth profile within the dot 412 can be more consistent, e.g., as compared to only following path 412a.

FIG. 4M shows another crescent shaped dot 413 formed by tracing the dot forming apparatus along a first path 413a and a second path 413b within the first path 413a. Compared to the crescent shaped dot 410, the aspect ratio of the dot 413 is lower, so the first and second paths 413a and 413b are closer in size compared to paths 410a and 410b.

FIG. 4N shows a cone shaped dot 414 formed by tracing the dot forming apparatus along a first path 414a and a second path 414b within the first path 414a. Both of paths 414a and 414b are composed of slightly curved segments.

FIG. 4O shows a polygonal dot 415 formed tracing the dot forming apparatus along a series of hexagonal paths 415a, e.g., a honeycomb lattice. The beam could follow various routes to form path 415a.

FIG. 4P shows a circular dot 416 formed by tracing the dot forming apparatus along a first path 416a and a second path 416b within the first path 416a. Both paths 416a and 416b are circular and concentric.

FIG. 4Q shows elliptical dot 417 formed by tracing the dot forming apparatus along a first path 417a and a second path 417b within the first path 417a. Both paths are elliptical and concentric.

FIG. 4R shows a rectangular dot 418 formed by tracing the dot forming apparatus along a first path 418a and a second path 418b within the first path 418a. Both paths are rectangular and concentric.

FIG. 4S shows a square dot 419 formed by tracing the dot forming apparatus along a first path 419a, a second path 419b within the first path 419a, and along a third path 419c within the second path 419b. Each of the paths are square. Since the width of the paths 419a and 419b are relatively large compared to the width of the beam following those paths, there is the additional path 419c to ensure a relatively smooth floor.

Generally, any number of closed paths can be sequentially scanned to form a dot having a desired shape, size, and floor. Other shapes are possible. Shapes that can be formed by scanning the dot forming apparatus along a single continuous path may be advantageous because they can be formed more efficiently (e.g., more quickly) than shapes formed by multiple separate paths. This is because a single continuous path typically avoids having to reset the dot forming apparatus by moving it from one path to the other.

The effect of dot size and shape on scattered can be studied empirically by physical light scattering experiments and/or by optical computer simulations. Optical simulation software was used to model the forward and backscattering properties of scatters having simple geometric shapes. For purposes of the simulation, a spectacle lens with dimensions of a plano lens (124 mm front R, 123.2 mm back R, 2 mm thickness) and a model eye with the same dimensions of the human eye was modeled. Three fields at 0 degrees, 20 degrees, and 40 degrees (full-field) were used in the model to account for central, near-periphery, and mid/far-periphery vision. In each case, all dots were modeled on the back surface of the lens (i.e., the surface facing the wearer).

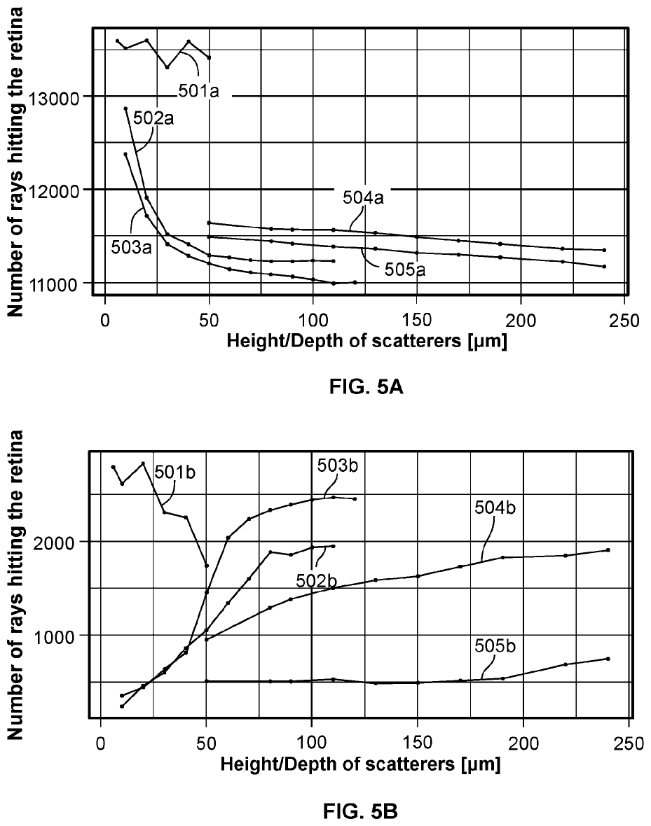

The results of these simulations are shown in the plots in FIGS. 5A and 5B. Here, FIG. 5A shows the number of simulated rays hitting the retina of a wearer for five different dots. FIG. 5B shows the number of simulated rays that are backscattered for the same five different dots. In each plot, the x-axis is the height or depth of the dot, depending on whether the dot was a protrusion or a depression.

Lines 501a and 501b correspond to dots formed from hemispheric protrusions. Increasing the height of these protrusions did not significantly change the total number of rays hitting the retina, but it changed the distribution of forward scattering and backscattering.

Lines 502a and 502b correspond to a hemispheric depression. Ray tracing showed that hemispheres with the smallest depth (10 μm) provided maximum forward scattering to the retina and minimum back scattering. Increasing the depth of hemispheres decreased the rays hitting the retina and increased the backscattering. This analysis showed that the trend was not linear, i.e., at ~50 μm depth, there was no further reduction in forward scattering and ~70 μm depth, there was no further increase in backscattered rays.

Lines 503a and 503b correspond to a depression shaped as a hemisphere with a concave end. Ray tracing showed that concave hemispheres with the smallest depth (10 μm) provided maximum forward scattering to the retina and minimum back scattering. Increasing the depth of hemispheres decreased the rays hitting the retina and increased the backscattering. The sharpest increase in backscattering occurred between 40 μm to 60 μm depth and the sharpest decrease in forward scattering occurred from 10 μm to 30 μm depth. This analysis showed that at ~50 μm depth, there was no further significant reduction in forward scattering and ~60 μm depth, there was no further increase in backscattered rays.

Lines 504a and 504b correspond to a depression shaped as an elongate hemisphere in the axial direction of the lens. Ray tracing showed that hemispheres with the smallest Z height (50 μm) provided maximum forward scattering to the retina and minimum back scattering. Increasing the length of hemispheres in Z direction decreased the rays hitting the retina and increased the backscattering; however, the rate of change was significantly smaller compared to the rate of change found by adjusting depth in hemispheres.

Lines 505a and 505b correspond to a depression shaped as an elongate hemisphere with a concave end. Ray tracing showed that elongated concave hemispheres with the smallest height (50 μm) provided maximum forward scattering to the retina and minimum back scattering. Increasing the length of concave hemispheres decreased the rays hitting the retina. Increasing the length of concave hemispheres from 50 to 170 μm did not significantly change the backscattering, however, there was a sharp increase in backscattering from 170 to 240 μm height.

Based on the simulations, both “hemispheres” and “hemispheres with concave end” showed the same trend, i.e., increasing the depth reduced forward scattered rays and increased backscattered rays. In both “hemispheres” and “concave hemispheres,” elongation of the scatterers in Z-direction did not significantly impact both forward and backward scattering. For bumps however, while a reasonable number of rays hit the retina for all depths, the backscattered rays were also high. With larger bumps, ray tracing suggests minimal impact on vision, because forward scattering is minimal. The range of 20 μm-30 μm achieved a balance between light scattering and contrast sensitivity for protrusions.

In certain examples, dots can be designed to deliver reduced narrow-angle scattering and increased wide-angle scattering to create even light distribution on retina/low contrast signal, while preserving acuity through geometry of scattering centers. For example, the dots can be designed to generate significant wide forward angle scattering (e.g., such as more than 10%, 20% or more, 30% or more, 40% or more, 50% or more, deflected by more than 2.5 deg.). Narrow angle forward scattering, i.e., within 2.5 deg., can be kept relatively low (e.g., 50% or less, 40% or less, 30% or less, 20% or less).

As noted above, dots can be formed on or in a lens (e.g., a stock lens) by adding material to the lens, by removing material from the lens, and/or by changing the optical properties of the lens material.

In some examples, dots are formed on a lens surface or within a bulk material of the lens by exposing the lens to laser radiation. The laser radiation locally interacts with the lens material (e.g., the bulk material and/or a coating material), creating a dot. Generally, lasers can be used to form dots either on a surface of a lens or in the bulk material of the lens. For example, exposure of a lens surface to a laser beam having sufficient energy can create a dot by leaving a small depression and/or roughened patch on the surface. By selectively exposing areas of the lens surface to laser radiation, a dot pattern can be formed on the surface. For example, the laser's beam can be moved relative to the surface while the beam is pulsed. Relative motion between the beam and the lens surface can be caused by moving the beam while leaving the surface fixed, moving the surface while leaving the beam fixed, or moving both the beam and the surface.

Generally, the optical properties of a dot formed using a laser on a lens surface can be influenced in several ways. For example, the energy density of a laser beam pulse will generally affect the physical and/or chemical interaction of the laser light with the lens material. For instance, for certain pulse energies, lens material can be melted where it is exposed to form a dot. At some pulse energies, dots can be formed by causing the lens material to foam. This can occur at higher energies relative to lens melting. For some pulse energies, the interaction between the laser light and the lens material can result in a color change to the lens material (e.g., by charring). In still other instances, lens material can be removed from a lens surface by ablation.

Other laser parameters can also influence the nature of dots formed using the laser. These include the laser wavelength, exposure time (for example, how long each dot location is exposed), and number of passes (e.g., exposing an area multiple times, where other areas are exposed between each), each of which can be selected to achieve a desired surface modification. In addition, the interaction between the laser light and the lens material will depend on the lens material itself. For example, dots in lens materials with lower glass transition temperatures may be formed using lower pulse energies or fewer pulses compared to dots in a lens material with a relatively higher glass transition temperature.

The resolution of the laser beam at the lens surface can be smaller than the desired dot size. For instance, the beam resolution (e.g., as determined from the FWHM of the intensity profile) can be about 50% of the dimension of the dot or less (e.g., about 25% or less, about 10% or less, about 5% or less, about 1% or less). In some embodiments, the beam can be capable of forming features having a dimension of 100 μm or less (e.g., 50 μm or less, 20 μm or less, 10 μm or less, 5 μm or less). In such cases, the laser can be used to form dots having complex perimeter shapes and/or a maximum width that is significantly larger than the focused dot size, but doing so involves scanning the laser over a path to form the dot.

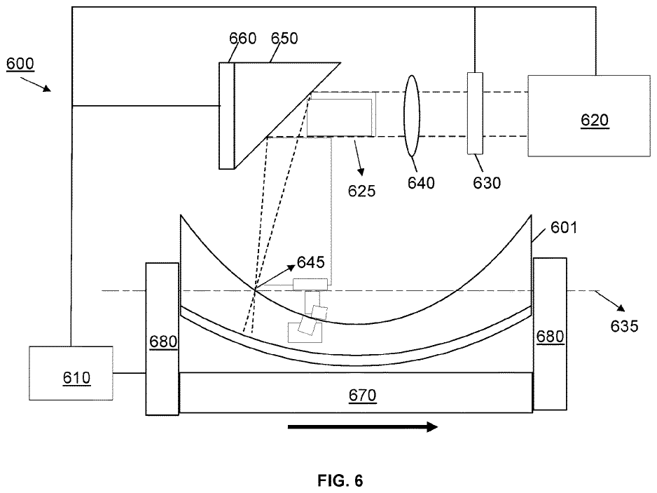

Referring to FIG. 6, a laser system 600 for forming dots on a surface of a lens includes a laser 620, a beam chopper 630, focusing optics 640, a mirror 650, and a stage 670. Laser 620 directs a laser beam towards mirror 650, which deflects the beam towards a lens 601 which is positioned relative to the mirror 650 by stage 670. An actuator 660 (e.g., a piezoelectric actuator) is attached to mirror 650. The stage includes a lens mounting surface 680 which supports lens 601. Laser system 600 also includes a controller (e.g., a computer controller) in communication with laser 620, beam chopper 630, and actuator 660.

Beam chopper 630 and focusing optics 640 are positioned in the beam path. Chopper 630 periodically blocks the beam so that lens 601 is exposed to discrete pulses of laser light. Focusing optics 640, which generally includes one or more optically powered elements (e.g., one or more lenses), focuses the beam to a sufficiently small spot on the surface of lens 601 so that the area ablated by the beam on the lens surface corresponds to the desired dot size. Actuator 660 changes the orientation of mirror 650 with respect to the beam to scan the pulsed beam to different target points on the lens surface. Controller 610 coordinates the operation of laser 620, chopper 630, and actuator 660 so that the laser system forms a predetermined dot pattern on the lens.

In some implementations, stage 670 also includes an actuator. The stage actuator can be a multi-axis actuator, e.g., moving the lens in two lateral dimensions orthogonal to the beam propagation direction. Alternatively, or additionally, the actuator can move the stage along the beam direction. Moving the stage along the beam direction can be used to maintain the exposed portion of the lens surface at the focal position of the beam, notwithstanding the curvature of the lens surface, thereby maintaining a substantially constant dot size across the lens surface. The stage actuator can also be controlled by controller 610, which coordinates this stage motion with the other elements of the system. In some embodiments, a stage actuator is used in place of the mirror actuator.

Generally, laser 620 can be any type of laser capable of generating light with sufficient energy to modify the lens material (e.g., bulk lens material or coating) to form dots. The laser can have a wavelength in the UV, visible, or IR portion of the electromagnetic spectrum. Gas lasers, chemical lasers, dye lasers, solid state lasers, and semiconductor lasers can be used. In some embodiments, infrared lasers, such as a CO₂ laser (having an emission wavelength at 9.4 μm or 10.6 μm) can be used. Commercially available laser systems can be used such as, for example, CO₂ laser systems made by Universal Laser Systems, Inc. (Scottsdale, AZ), (e.g., the 60W VLS 4.60 system). In some implementations, femtosecond lasers can be used. For example, a commercial femtosecond laser system such as those made by Trumpf (Santa Clara, CA) (e.g., as the TruMicro 2030 laser device of the TruLaser Station 5005) can be used to form a dot pattern of a desired shape and size. The burst mode of such a laser device can achieve burst energy that is much higher compared to the maximum energy of a single pulse, leading to higher ablation rates. This exemplary laser system can provide pulse duration of less than 400 femtoseconds with 50 μJ maximum pulse energy.

The pulse duration and pulse energy are typically selected to provide a dot of a desired size. For example, in some embodiments, laser 620 forms the predetermined dot pattern on lens 601 by melting material at the surface of lens 601. For example, laser 620 heats up and melts a portion of lens 601 surface to form the predetermined pattern as the laser etching causes the melted material of lens 601 to expand, causing the raised mark that forms the predetermined dot pattern.

In certain implementations, laser 620 forms the predetermined dot pattern on lens 601 using laser foaming. For example, the laser 620 uses laser foaming to melt and affix a polymer material onto lens 601 where laser 620 marked the foam, thus forming the predetermined dot pattern.

In some examples, laser 620 forms the predetermined dot pattern on lens 601 using laser marking. For example, laser marking forms the predetermined dot pattern on lens 601 by inducing color changes on lens 601, e.g., due to chemical or physical alteration of the portion of the lens 601 that forms the predetermined dot pattern. In another example, the laser 620 forms the predetermined dot pattern on lens 601 by using laser marking to char the lens 601 to form the predetermined dot pattern on lens 601.

In some implementations, laser 620 forms the predetermined dot pattern on lens 601 using ablation. For example, laser 620 is used to ablate (e.g., remove material) lens 601 by evaporating or sublimating the lens 601 to form the predetermined dot pattern. After ablation, a crater may form on lens 601.

In some examples, to reduce conspicuousness of the dot pattern (e.g., to reduce backward scattering and reflection at the scattering center due to the ablation crater), the surface of the ablation crater on lens 601 is modified to reduce surface roughness (e.g., to create a dot with a large floor dimension relative to the dot size and with a small dF relative to the depth of the dot). Reducing surface roughness can reduce the effects of small angle light scattering (e.g., where scattering angle is less than 3 degrees). For example, the surface of an ablation crater on lens 601 can be modified by second pass ablation to melt the rough surface of the ablation crater (e.g., by using a lower energy ablation). The lower energy ablation can be performed, for example, by defocusing laser 620 (e.g., by increasing laser 620 beam width). In some implementations, continuing to reduce conspicuity of the dot pattern involves defocusing laser 620 over multiple iterations. For example, defocusing laser 620 occurs in several passes (e.g., with each second, third, fourth, etc. ablation pass) with increased defocusing (e.g., increasing beam width with each pass) to influence conicity of the crater (e.g., feathering or smoothing the crater edge). In some implementations, reducing conspicuousness of the dot pattern involves multiple overlapping ablations being performed to compose one ablation crater with multiple overlapping ablation craters.

In some implementations, reducing conspicuousness of the dot pattern involves coating an anti-reflective layer on the back surface of lens 601. In some implementations, a reflective layer is coated on the lens front surface. This is particularly beneficial if the laser ablation is performed on the back surface of lens 601. Generally, laser 620 has a stronger impact on the coating than the lens 601 material, thus influencing conicity of the crater (e.g., feathering or smoothing of the crater edge).

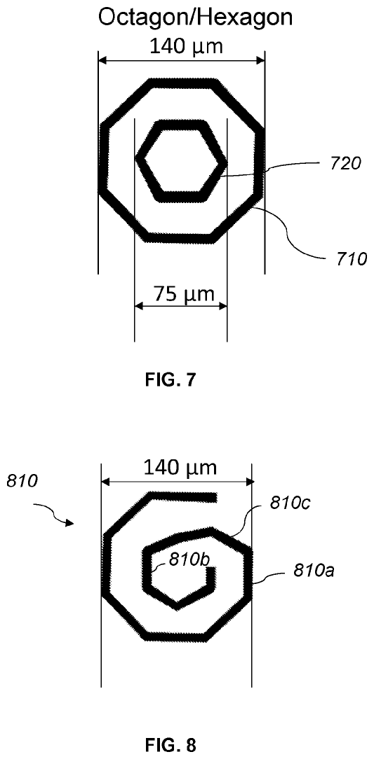

Two examples of laser paths for forming dots each having a width of 140 μm are shown in FIGS. 7 and 8, respectively. FIG. 7 shows a dot shape that is formed by scanning two discrete paths 710 and 720. The outer path 710 is octagonal. The inner path 720, having a width of 75 μm is hexagonal. Scanning these paths involves moving the laser from the first path to the second without exposing the lens surface.

FIG. 8 shows a segmented spiral path 810 of the laser forming the same octagonal shape as the dots show in FIG. 7 in the outer portion 810a of the spiral path 810. The inner portion 810 b of the spiral path 810 follows a hexagonal shape that is rotated 60 degrees relative to the path 720, and intermediate portion 810c of the path connects the inner and outer portions 810b and 810a. Here the dot is formed by tracing the laser along a single continuous path, so moving the laser from one path to the next to complete forming the dot is not necessary. Such a dot can be formed more quickly than dots that involve more than one discrete path. Moreover, such paths can result in dots with a smoother floor compared to similar sized dots having been formed by scanning multiple discreet paths.

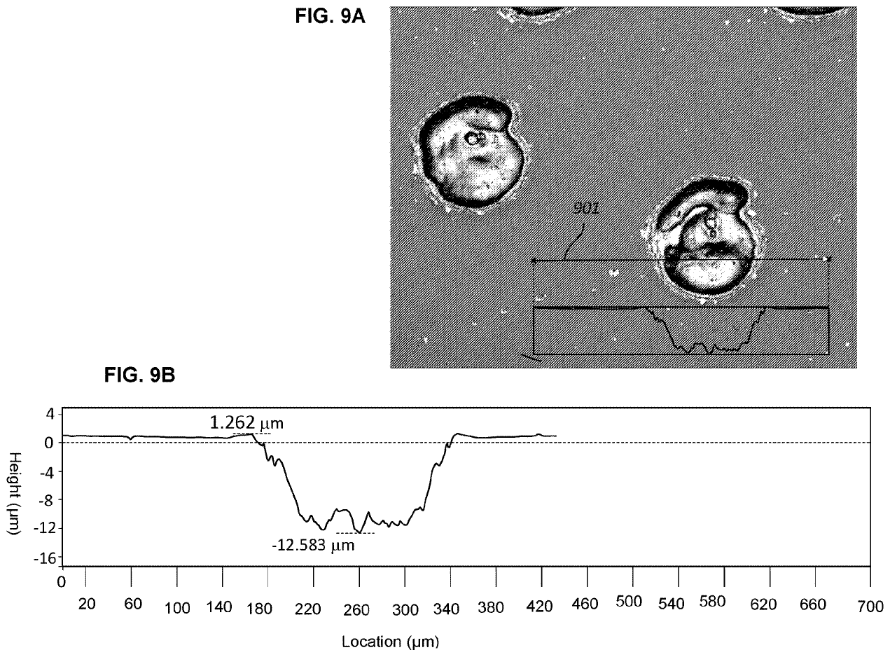

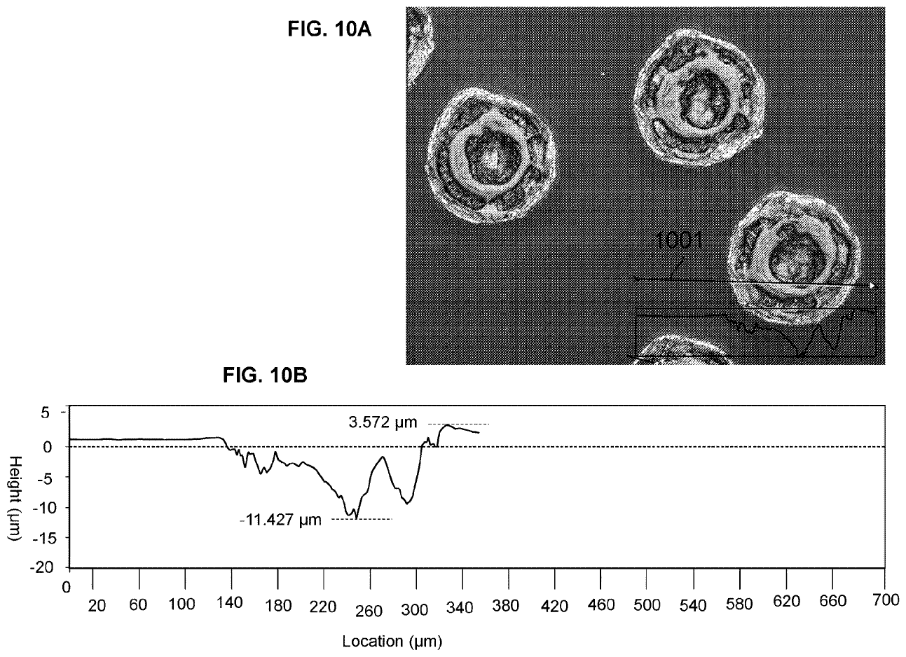

This is evident in a comparison of the dots shown in FIGS. 9A and 9B and FIGS. 10A and 10B, which correspond to dots formed using the paths shown in FIG. 8 and FIG. 7, respectively. In particular, FIGS. 9A and 9B show two dots formed using a spiral path as illustrated in FIG. 8. This view of the dots was acquired using optical interferometry. FIG. 9B shows a cross-sectional profile from through a section of one of the dots, e.g., the height versus the location along the line 901 in FIG. 9A. For example, the dot in FIGS. 9A and 9B has a maximum height of 1.262 μm above the surface, e.g., 0 μm, and a minimum height of −12.583 μm below the surface, e.g., spanning a range of about 14 micron.

FIG. 10A shows a top view of three dots formed using the dual paths shown in FIG. 7. FIG. 10B shows a profile, e.g., the height versus the location along line 1001 in FIG. 10A, through one of the dots illustrating the significantly higher surface roughness at the floor of one of these dots compared to those in FIG. 9A. For example, the dot in FIGS. 10A and 10B has a maximum height of 3.572 μm above the surface, e.g., 0 μm, and a minimum height of −11.427 μm below the surface, e.g., spanning a range of about 15 micron.

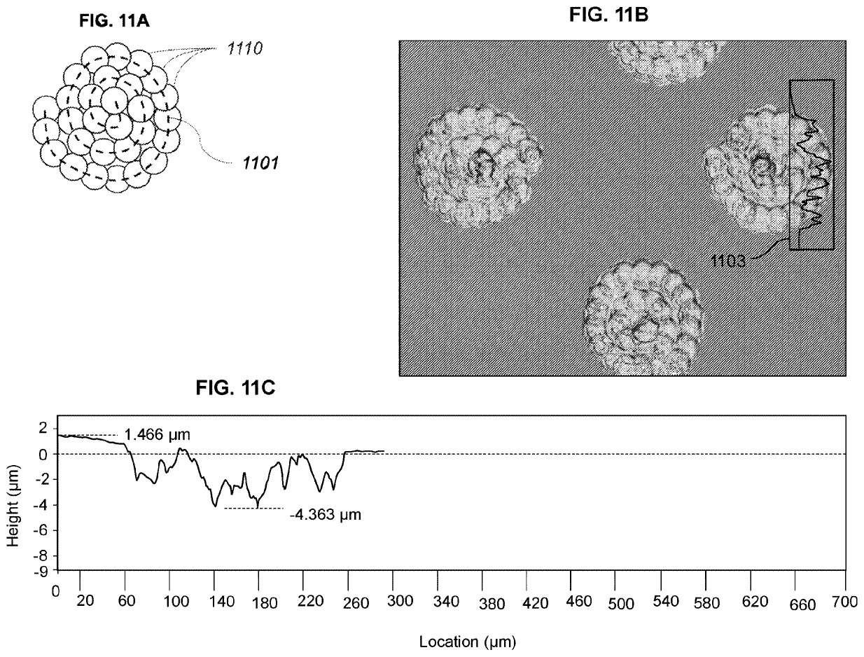

These two examples are laser exposures that involve continuous exposure of the lens surface while the laser scans each discrete path. However, other exposure schemes are possible. For example, in some cases a laser can be pulsed while it is scanned along a discrete path. An example of this is shown in FIG. 11A which shows a spiral path 1101. The laser is pulsed as the laser is scanned along the path 1101, resulting in multiple individual exposure areas. The spiral path is sufficiently tightly wound relative to the focal spot size so that the exposure areas overlap along the path and also with the exposure areas in adjacent loops of the spiral. The result is an approximately circular dot with a relatively smooth floor. Furthermore, such exposure schemes can result in a lower overall laser dose to delivered to the area of the lens, resulting in a shallower dot compared to forming a dot with a single, continuous exposure.

Examples of dots formed using a spiral path and a pulsed laser are shown in FIG. 11B, which shows a top view of three such dots. FIG. 11C shows the cross-sectional profile of one of the dots, e.g., the height versus the location along line 1103 of FIG. 11B. In this example, the maximum height of the dot is 1.466 μm above the surface, and the minimum height is about 4.363 μm. The floor roughness through this section is only slightly smaller than the depth, but overall the floor has a relatively small roughness given how shallow the dot is. In other words, although the fluctuation dF is not much smaller than the depth D, the depth D is quite shallow, and the absolute value of dF is small.

Laser formation of dots can result in a phenomenon referred to as “burn in” where the initial exposure location at the start of the laser path results in a deep portion of the dot compared to the rest of the dot. Such burn in can manifest as a trench on one side of a dot. The asymmetry resulting from such burn in trenches can result in asymmetric scattering from different portions of the dot. In some implementations, e.g., where burn in is unavoidable, it may be desirable to form burn in trenches symmetrically at different locations in a dot to reduce asymmetric scattering. Moreover, the location of burn in trenches can be varied for different dots across a lens in order to reduce the overall asymmetry of scattering, or to harness the asymmetry, over the entire reduced contrast region of the lens.

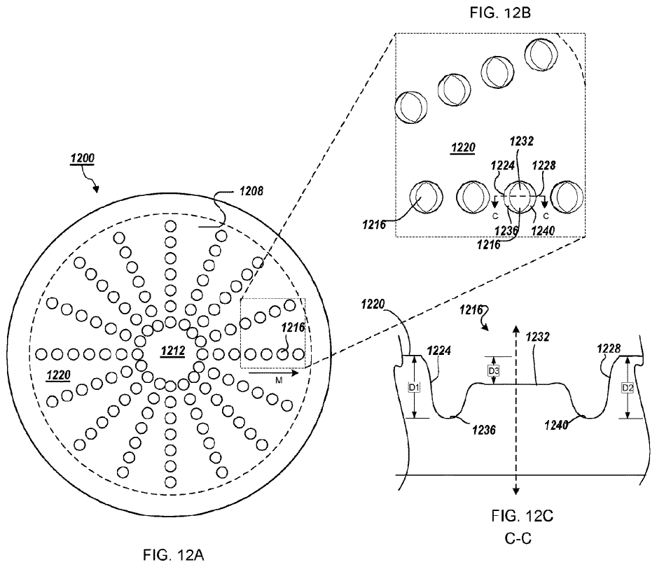

Such an example is described now with reference to FIGS. 12A-12C. FIG. 12A shows a plan view of a lens 1200 with a reduced contrast region 1208 surrounding a clear aperture 1212. The reduced contrast region 1208 includes dots 1216 arranged in a pattern of radial arrays. Each dot 1216 includes a depression formed in a surface 1220 of the lens 1200 using a symmetrical burn-in technique that results in two trenches on opposing sides of the dot.

This is illustrated in FIGS. 12B and 12C, which show a plan view of a portion of the reduced contrast region 1208 and a cross-section through one of the dots, respectively. Each dot 1216 includes a first sidewall 1224, a second sidewall 1128, and a central area 1232 between the sidewalls 1224, 1228. The depth profile (FIG. 12C) shows the depression created by the burn-in of laser radiation during dot formation that includes trenches 1236 and 1240 adjacent sidewalls 1224 and 1228, respectively.

The first trench 1236 has a depth DI that is substantially equal to a depth D2 of the second trench 1240. The central area 1232 disposed between the first and second trenches 1236, 1240 has a depth D3 that is less than the depth D1 of the first trench 1236 and the depth D2 of the second trench 1240.

A “trench” as used herein may include a groove, channel, cavity, or dimple with a depth that is greater than a depth of adjacent parts. Generally, trenches on opposing sides of a dot can have the same depth or different depths.

As shown in FIG. 12B, the width of the trenches is not constant around the perimeter of the dot. Rather, each trench is crescent shaped, having a widest part corresponding to section C and a narrowest part through the section perpendicular to C. The orientation of the crescent shaped trenches is aligned with the radial direction of the dot arrays in the reduced contrast region 1208. This variation in the alignment of the trenches can provide increased overall homogeneity in light scattering averaged across the reduced contrast region.

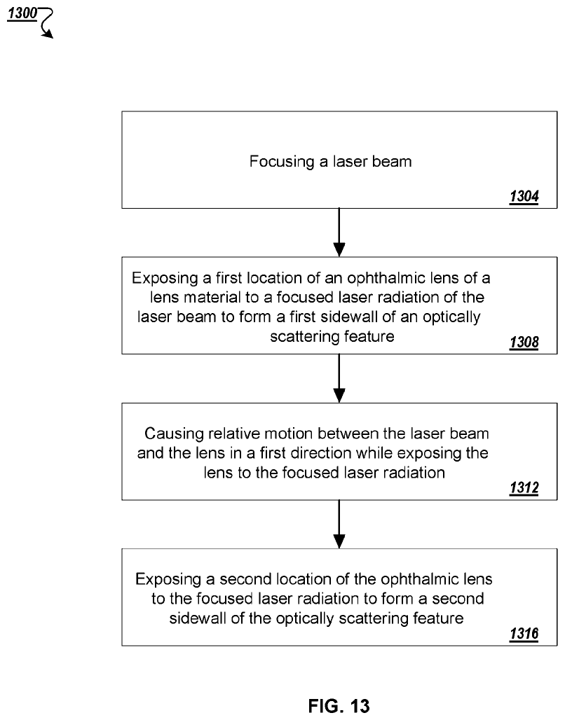

The varying depths of the depth profile illustrated in FIG. 12C may be formed using laser burn-in in a variety of ways. A first example method 1300 of forming the dot 1216 with a symmetrical depth profile is illustrated in FIG. 13. In this method 1300, the time of laser exposure at various locations of the dot 1216 is controlled to create a symmetrical burn-in depression. Initially, a first step 1304 of the method 1300 includes focusing a laser beam of a laser system. A second step 1308 of the method 1300 includes exposing a first location of an ophthalmic lens 1200 of lens material to focused laser radiation of the laser beam. Specifically, when forming a new dot 1216 in the surface 1220 of the lens 1200, the laser exposes the lens surface 1220 to an initial burst of intense laser radiation, thereby creating an initial burn-in that defines the first sidewall 1224 and first trench 1236 that is inwardly disposed relative to the first sidewall 1224. In a third step 1312, the method 1300 includes causing relative motion between the laser beam and the lens in a first direction M, away from the first trench 1236, while exposing the lens 1200 to the focused laser radiation. In some examples, the laser moves relative to the lens 1200 in the M direction away from the first sidewall 1224 to continue forming the remainder of the dot depression. While the laser moves in the direction M, the lens 1200 is continually exposed to the focused laser radiation of the laser beam, creating a burn-in that defines the central area 1232 of the dot 1216. The intensity of the laser beam while forming the central area 1232 is weaker than the initial burst of laser radiation, and therefore a depth D3 of the central area 1232 is less than the depth D1 of the first trench 1236.

In a fourth step 1316, the method 1300 includes exposing a second location of the ophthalmic lens to the focused laser radiation to form the second sidewall 1228 and second trench 1240 that is disposed inwardly relative to the second sidewall 1228 of the dot 1216. Again, because the intensity of the laser is weaker than the initial burst of radiation, the laser pauses for a period of time to expose the second trench 1240 to sufficient radiation to create a burn-in with a depth D2 that is substantially equal to the depth D1 of the first trench 1236. Accordingly, the lens 1200 is exposed to the laser beam at the second trench 1240 for a period of time that is greater than the initial exposure at the first trench 1236.

In some examples, the intensity of the laser beam is controlled to create a symmetrical burn-in depression. In this example, the laser beam exposes the lens 1200 to a first laser intensity to create the first trench 1236 and exposes a different location of the lens 1200 to the first laser intensity to create the second trench 1240.

In some examples, the intensity and the exposure time are controlled to create the symmetrical burn-in depression. In another example, the laser exposure may be pulsed to create short and intense bursts of laser radiation to form the first and second trenches of the dot before forming the central area.

In some cases, the dot pattern includes randomly displacing dots with respect to a regular array. Introducing random displacements can reduce optical effects associated with regularly spaced scattering centers, such as starburst-like glare. See, e.g., https://www.slrlounge.com/diffraction-aperture-and-starburst-effects/which illustrates the starburst effect as it relates to photography. Accordingly, including random displacements in dot patterns can provide the user with a more comfortable experience compared with similar dot patterns in which the scattering centers are uniformly spaced. Alternatively, or additionally, randomization of the dot pattern can reduce the optical effects (e.g., diffractive or interference effects) that manifest in reflected light, reducing the noticeability of the dot patterns to observers.

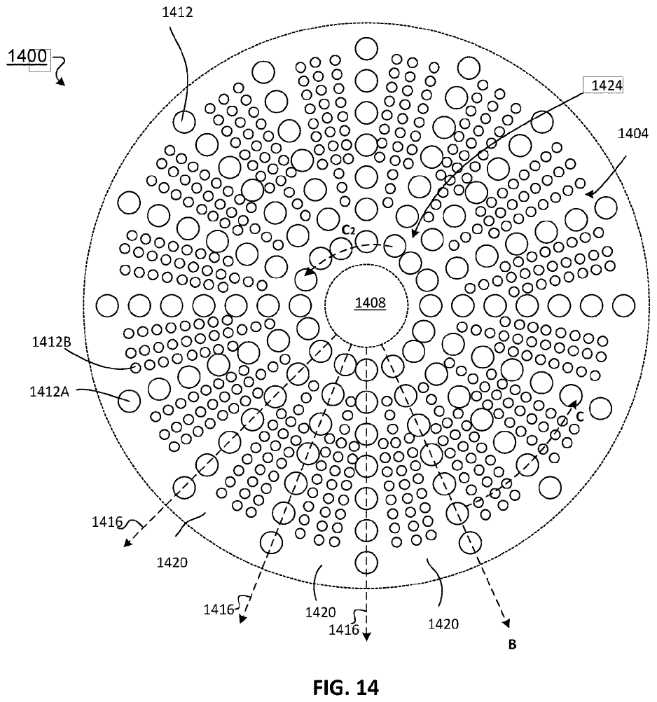

Referring to FIG. 14, an example dot pattern 1400 includes an annular region 1404 surrounding a clear aperture 1408. The annular region has dots 1412 arranged in a pattern 1400 that includes a radial direction B and a circumferential direction C. Specifically, the dots 1412 are arranged along a plurality of radial arrays 1416 relative to the clear aperture 1408 as well as in spaces 1420 between the different radial arrays 1416. Specifically, dots 1412A of a first size are arranged along the radial arrays 1416 and dots 1412B of a different size are arranged in the spaces 1420 between the radial arrays 1416. According to the pattern 1400, when moving in the circumferential direction C, the dot size changes and when moving in the radial direction B, the dot size remains uniform.

The pattern 1400 also includes a second annular region 1424 within annular region 1404 and adjacent to the aperture 1408, in which the dots 1412A are the first size. In the second annular region 1424, the dot size is constant in both radial B and circumferential directions C2. However, in other examples the pattern 1400 may include only one annular region or more than two annular regions having varied patterns of dots.

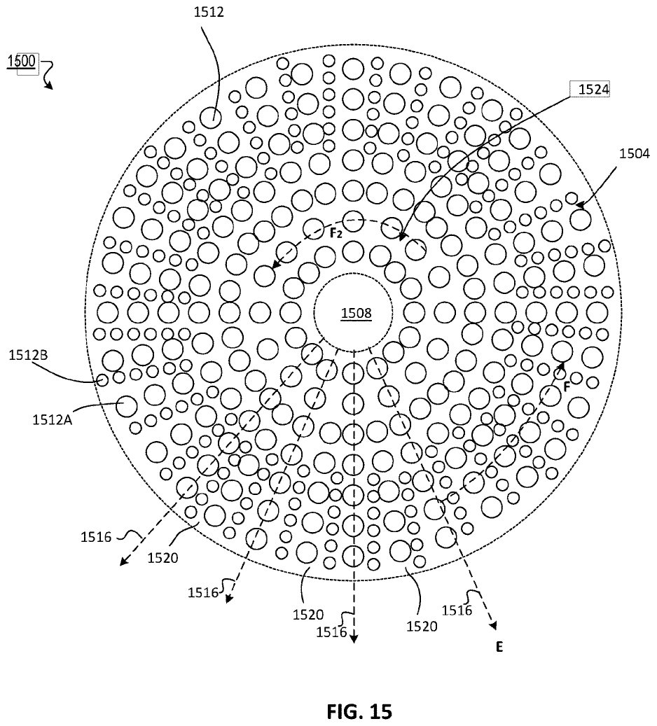

FIG. 15 is another example dot pattern 1500 and includes an annular region 1504 surrounding a clear aperture 1508. The annular region 1504 has spaced apart dots 1512 arranged in a pattern that includes a radial direction E and a circumferential direction F. Specifically, the dots 1512 are arranged along multiple radial arrays 1516 relative to the aperture 1508 and in spaces 1520 between the different radial arrays 1516. Specifically, dots 1512A of a first size are arranged along the radial arrays 1516 and dots 1512B of a different size are arranged in the spaces 1520 between the radial arrays 1516 within the first annular region 1504. According to the pattern 1500, when moving in the circumferential direction F, the dot size changes and when moving in the radial direction E, the dot size remains uniform.

The pattern 1500 also includes a second annular region 1524 adjacent within the annular region 1504 to the aperture 1508, in which the dots 1512A are the first size. In the second annular region 1524, the dot size is uniform in both radial E and circumferential directions F2.

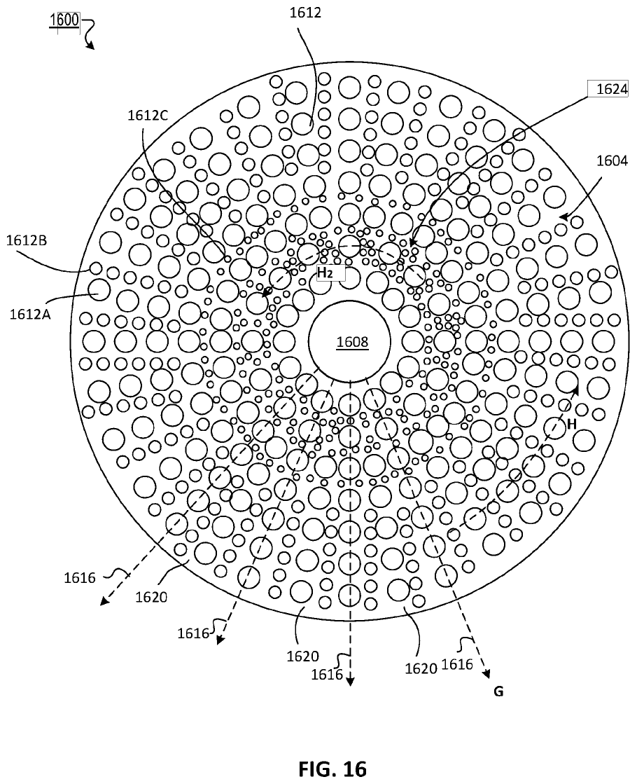

In FIG. 16, another example dot pattern 1600 for an ophthalmic lens includes an annular reduced contrast region 1604 surrounding a clear aperture 1608. The annular region 1604 has spaced apart dots 1612 to scatter incident light. The dots 1612 are arranged in a pattern that includes a radial direction G and a circumferential direction H. Specifically, the plurality of dots 1612 are arranged along multiple radial arrays 1616 relative to the aperture 1608 and in spaces 1620 between the different radial arrays 1616. Dots 1612A of a first size are arranged along the radial arrays 1616 and dots 1612B of a second, smaller size are arranged in the spaces 1620 between the radial arrays 1616 within the first annular reduced contrast region 1604. According to the pattern 1600, when moving in the circumferential direction H, the dot size changes and when moving in the radial direction G, the dot size remains uniform.

The pattern 1600 also includes a second annular region 1624 adjacent to the aperture 1608, in which the dots 1612C of a third size are arranged between the dots 1612A of the first size. In the second annular region 1624, the dot size varies in the circumferential direction H2. The dots 1612C of the third size are arranged in a different pattern that includes an irregular variation in spacing between adjacent dots 1612A. In the illustrated example, the dots 1612C of the third size are randomly disposed between the radial arrays 1616. However, in other examples, the dots 1612C of the third size (e.g., smaller than dots 1612A and 1612B) may be uniformly spaced between adjacent dots 1612A, 1612C. In yet another example, dots 1612B of the second size may also be disposed adjacent to the other sized dots 1612A, 1612C.

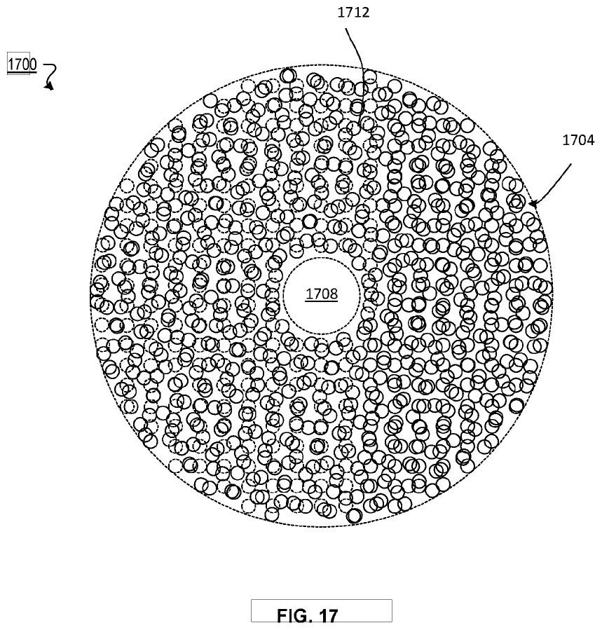

While the foregoing example dot patterns described with respect to FIGS. 12A, 14, 15, and 16 are each composed of spaced apart dots, patterns with overlapping dots are also possible. For example, referring to FIG. 17, an example dot pattern 1700 includes an annular reduced contrast region 1704 surrounding a clear aperture 1708, and overlapping dots 1712 to scatter incident light in the annular reduced contrast region 1704. The dots 1712 are arranged in a random pattern 1700 and are of uniform size. In some cases, one dot overlaps with one other dot, and in other cases, with two or more other dots. The dots 1712 may simply touch or overlap with each other in varying degrees (e.g., from about 1% to about 99% overlap in dot surface area). For example, dot overlap, as determined by a percentage of the dot's area that overlaps with one or more other dots, can be 5% or more (e.g., 10% or more, 15% or more, 20% or more, 25% or more, 30% or more, 35% or more, 40% or more, 45% or more, 50% or more, 55% or more, 60% or more, 65% or more, 70% or more, 75% or more, 80% or more, 85% or more, 90% or more, or 95% or more).

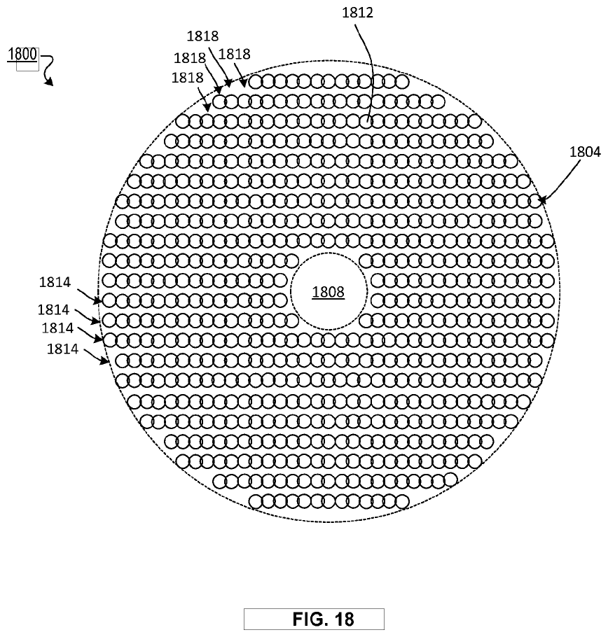

FIG. 18 is another example dot pattern 1800 that includes an annular reduced contrast region 1804 surrounding a clear aperture 1808 and overlapping dots 1812 for scattering light in the reduced contrast region. The dot pattern 1800 includes a grid of perpendicular rows 1814 and columns 1818. In the illustrated example, the dots 1812 arranged in the rows 1814 overlap with adjacent dots 1812 of the same row 1814. However, the dots 1812 in the columns 1818 do not overlap with an adjacent dot 1812 of the same column 1818. The plurality of dots 1812 may simply touch or overlap with each other in varying degrees (e.g., from about 1% to about 99% overlap by area).

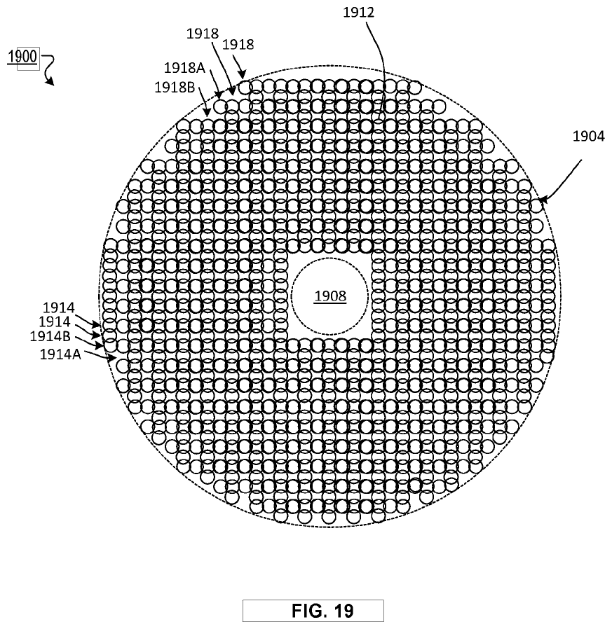

In FIG. 19, another example dot pattern 1900 includes an annular reduced contrast region 1904 surrounding a clear aperture 1908 dots 1912 to scatter incident light in the reduced contrast region. The dot pattern 1900 includes a grid of rows 1914 and columns 1918 in which the dots 1912 arranged in rows 1914 overlap with an adjacent dot 1912 of the same row 1914, and the dots 1912 arranged in columns 1918 overlap with an adjacent dot 1912 of the same column 1918. In the illustrated example, some dots 1912 do not overlap with an adjacent dot 1912 in the same row (e.g., row 1914A), and some dots 1012 do not overlap with an adjacent dot 1912 in the same column (e.g., column 1918A). In some rows 1914 and columns 1918 (e.g., row 1914B, column 1918B), some dots 1912 overlap with an adjacent dot 1912 in both the same column 1918 and the same row 1914. The plurality of dots 1912 may simply touch or overlap with each other in varying degrees (e.g., from about 1% to about 99% overlap by area).

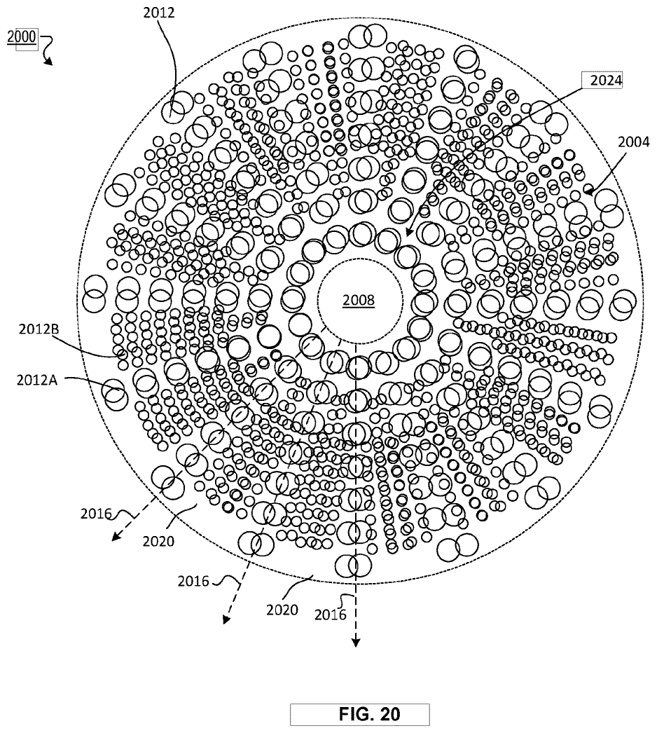

In FIG. 20, yet another example dot pattern 2000 for an ophthalmic lens includes reduced contrast region composed of a first annular region 2004 and a second annular region 2024 surrounding a clear aperture 2008, and an overlapping dots 2012 to scatter incident light in the first and second annular regions 2004, 2024. The dot pattern 2000 includes a plurality of dots arranged in both radial directions and circumferential directions relative to the aperture 2008. Specifically, the plurality of dots 2012 are arranged to overlap along a plurality of radial arrays 2016 relative to the aperture 2008 and in spaces 2020 between the different radial arrays 2016. A plurality of dots 2012A of a first size are arranged along the radial arrays 2016 in both annular regions 2004, 2024, and a plurality of dots of a different size 2012B are disposed in the spaces 2020 between the radial arrays 2016 and within the first annular region 2004. The pattern 2000 also includes a second annular region 2024 adjacent to the aperture 2008, in which the dots 2012A are the first size. In some cases, the dots 2012 overlap with adjacent dots of the same and/or different size. In some cases, one dot 2012 overlaps with one other dot 2012, and in other cases, with two or more other dots 2012. The plurality of dots 2012 may simply touch or overlap with each other in varying degrees (e.g., from about 1% to about 99% overlap). In other cases, the dots 2012 do not overlap with any other dots 2012.

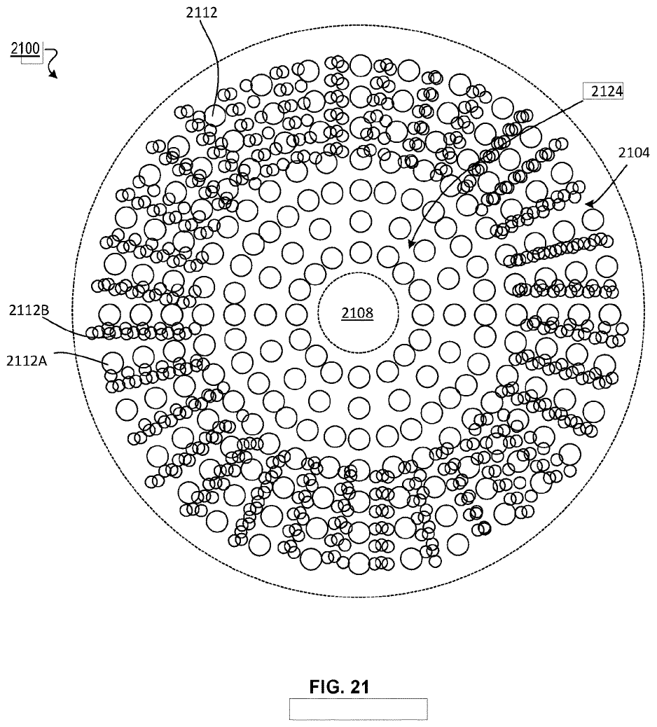

In another example in FIG. 21, a dot pattern 2100 for an ophthalmic lens includes a reduced contrast region that has a first annular region 2104 and a second annular region 2124 that surrounds a clear aperture 2108, and dots 2112 in the first and second annular regions 2104, 2124. In the first annular region 2104, some of the dots 2112 of varying size overlap with adjacent dots 2112 of the same or different size. In the second annular region 2124, the dots 2112 are of a uniform size and do not overlap with adjacent dots 2112. In some cases, the dots 2112 overlap with adjacent dots 2112 of the same and/or different size. In some cases, one dot 2112 overlaps with one other dot 2112, and in other cases, with two or more other dots 2112. The plurality of overlapping dots 2112 may simply touch or overlap with each other in varying degrees (e.g., from about 1% to about 99% overlap by area).

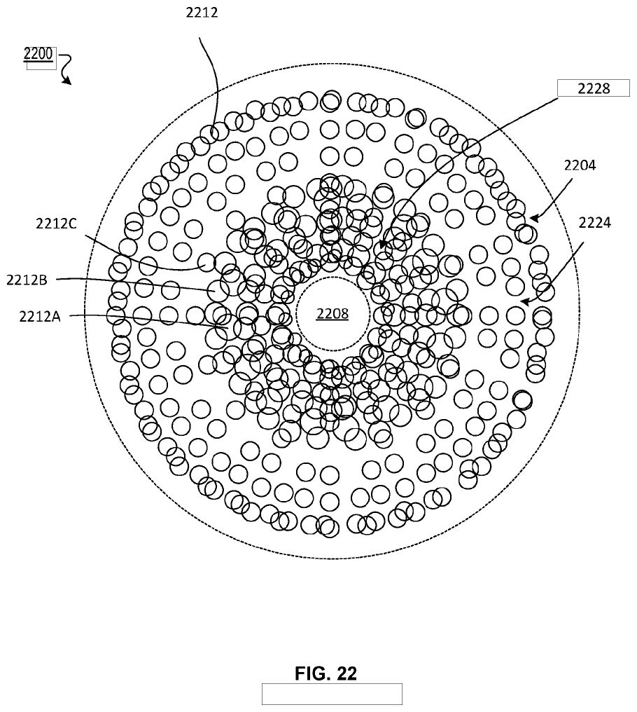

FIG. 22 illustrates yet another example dot pattern 2200 for an ophthalmic lens, which includes a reduced contrast region with a first annular region 2204, a second annular region 2224, and a third annular region 2228. The third annular region 2228 surrounds a clear aperture 2208 and has overlapping dots 2212 of different sizes 2212A, 2212B, 2212C arranged in a random pattern. In some cases, the dots 2212 overlap with adjacent dots 2212 of the same and/or different size. The dots 2212 in the second annular region 2224 do not overlap, and the dots 2212 in the first annular region 2228 overlap with one or more adjacent dots 2212. In some cases, one dot 2212 in the first and third annular regions 2204, 2228 overlaps with one other dot 2212, and in other cases, with two or more other dots 2212. The plurality of overlapping dots 2212 may simply touch or overlap with each other in varying degrees (e.g., from about 1% to about 99% overlap by area).

In some examples, the dot pattern features a gradient in, e.g., dot size and/or spacing. Dot patterns can feature a gradient in scattering efficiency of the dots (e.g., due to a gradient in the refractive index mismatch and/or shape of each dot). Graded dot patterns can reduce the conspicuity of the pattern. For example, a graded transition from the clear portions of the lens to the scattering portion can be less conspicuous than a sharp transition.

In addition to the embodiments of the attached claims and the embodiments described above, the following numbered embodiments are also innovative.

Embodiment 1 is an ophthalmic lens, including: a lens body having a pair of opposing curved surfaces; a plurality of discrete light scattering centers arranged in an area of at least one of the opposing curved surfaces, each scattering center having a shape defined, at least in part, by a perimeter shape, a maximum depth, D, and a maximum width, W, wherein a ratio D/W is ⅕ or less.

Embodiment 2 is an ophthalmic lens, including: a lens body having a pair of opposing curved surfaces; a plurality of discrete light scattering centers arranged in an area of at least one of the opposing curved surfaces, each scattering center having a shape defined, at least in part, by a perimeter shape, a maximum depth, D, and a maximum width, W, wherein D is of 20 micrometers (μm) or less and W is 100 μm or more.

Embodiment 3 is an ophthalmic lens, including: a lens body having a pair of opposing curved surfaces defining a lens axis; a plurality of discrete light scattering centers arranged in an area of at least one of the opposing curved surfaces, each scattering center having including a depression having a maximum depth, D, and a maximum width, W, and a floor having a minimum width, W_{floor}, and a maximum depth variation, δD_{floor}, wherein W_{floor} is 0.5 W or more and the δD_{floor} is 0.2 D or less.

Embodiment 4 is an ophthalmic lens, including: a lens body having a pair of opposing curved surfaces defining a lens axis; a plurality of discrete light scattering centers arranged in an area of at least one of the opposing curved surfaces, each scattering center having a shape defined, at least in part, by a perimeter shape, a maximum depth and a maximum width, wherein the perimeter shape is selected from the group consisting of a star, a regular polygon, a dumbbell, a pear shape, a parallelogram, a crescent, a cone, and a zig-zag.

Embodiment 5 is an ophthalmic lens, including: a lens body having a pair of opposing curved surfaces; a plurality of discrete light scattering centers arranged in an area of at least one of the opposing curved surfaces, wherein, a density of the light scattering centers in the area and the shape of the light scattering centers are selected so that, for light incident on the area of the lens propagating parallel to the lens axis, the ophthalmic lens backscatters 12% or less of the light incident on the area and forward scatters other light incident on the area, 50% or more of the forward scattered light being forward scattered into a solid angle of 5 degrees.

Embodiment 6 and an ophthalmic lens of any one of the previous embodiments, wherein the area surrounds a clear area devoid of scattering centers.

Embodiment 7 is an ophthalmic lens of any one of the previous embodiments, wherein the area is an annular area.

Embodiment 8 is an ophthalmic lens of any one of the previous embodiments, wherein the light scattering centers are formed on a single surface of the ophthalmic lens.

Embodiment 9 is an ophthalmic lens of any one of embodiments 1-7, wherein the light scattering centers are formed only on a single surface of the ophthalmic lens.

Embodiment 10 is an ophthalmic lens of embodiment 9, wherein the single surface if a concave surface.

Embodiment 11 is an ophthalmic lens of embodiment 9, wherein the single surface if a convex surface.

Embodiment 12 is an ophthalmic lens of any one of the previous embodiments, wherein each of the scattering centers have the same shape.

Embodiment 13 is an ophthalmic lens of any one of embodiments 1-11, wherein at least some of the scattering centers have different shapes.

Embodiment 14 is an ophthalmic lens of any one of the previous embodiments, wherein the ophthalmic lens is a spectacle lens or a contact lens.

Embodiment 15 is an ophthalmic lens of any one of the previous embodiments, wherein the ophthalmic lens is a plano lens, a single vision lens, or a multifocal lens.

Embodiment 16 is a method, including: exposing a surface of an ophthalmic lens to one or more pulses of laser radiation sufficient to create a light scattering center in the surface; and moving the laser radiation relative to the surface while exposing the surface to trace a path on the surface, wherein the path has a spiral shape and the light scattering center has a maximum width, W, in a range from 100 micrometers to 1,000 micrometers.

Embodiment 17 is a method, including: exposing a surface of an ophthalmic lens to one or more pulses of laser radiation sufficient to create a light scattering center in the surface; and moving the laser radiation relative to the surface while exposing the surface to trace a path on the surface, wherein the light scattering center has a maximum width, W, in a range from 100 micrometers to 1,000 micrometers and a perimeter shape selected from the group consisting of a star, a regular polygon, a dumbbell, a pear shape, a parallelogram, a crescent, a cone, and a zig-zag.

Embodiment 18 is an ophthalmic lens, including: a lens body having two opposing surfaces; and an annular region surrounding a clear aperture, wherein the annular region has a plurality of light scattering centers in the lens body and/or on at least one of the two opposing surfaces sized and shaped to scatter incident light, wherein a light first scattering center of the plurality of light scattering centers overlaps with an adjacent light scattering center.

Embodiment 19 is an ophthalmic lens of embodiment 18, wherein the light scattering centers are arranged in a pattern that includes rows, wherein the first light scattering center and the adjacent light scattering center are disposed in a row.

Embodiment 20 is an ophthalmic lens of embodiment 19, wherein the light scattering centers are arranged in a pattern that includes of columns.

Embodiment 21 is an ophthalmic lens of embodiment 20, wherein a second light scattering center overlaps with a third light scattering center in a column.

Embodiment 22 is an ophthalmic lens of embodiment 20 or 21, wherein the first light scattering center overlaps with different light scattering center, the first scattering center and the different light scattering center are disposed in a column.

Embodiment 23 is an ophthalmic lens of embodiment 18, wherein the first light scattering center is a first size, and the adjacent light scattering center is a second size different than the first size.

Embodiment 24 is an ophthalmic lens of embodiment 18, wherein the light scattering centers are arranged in a pattern that includes a circumferential direction and a radial direction relative to the clear aperture.

Embodiment 25 is an ophthalmic lens of embodiment 18, wherein the light scattering centers are arranged in a pattern that includes an irregular variation in spacing between adjacent light scattering centers.

Embodiment 26 is an ophthalmic lens of any one of embodiments 18 through 25, including a second annular region, wherein the light scattering centers disposed in the second annular region do not overlap.

Embodiment 27 is an ophthalmic lens of embodiment 18, wherein the lens has a lens axis, and the aperture and annular region are substantially centered on the lens axis.

Embodiment 28 is an ophthalmic lens, including: a lens body having two opposing surfaces; and an annular region surrounding a clear aperture, wherein the annular region has a plurality of spaced apart light scattering centers in the lens body and/or on at least one of the two opposing surfaces sized and shaped to scatter incident light, the light scattering centers being arranged in a pattern that includes a circumferential direction and a radial direction relative to the clear aperture, wherein the light scattering centers arranged along the radial direction have a first size, and the light scattering centers arranged along the circumferential direction have a second size different than the first size.

Embodiment 29 is an ophthalmic lens of embodiment 28, wherein the first size is uniform, and the second size is variable.

Embodiment 30 is an ophthalmic lens of embodiment 28, including a second annular region disposed between the clear aperture and the annular region, wherein the light scattering centers disposed in the second annular region are uniform in size in both the radial and circumferential directions.

Embodiment 31 is an ophthalmic lens of embodiment 28, wherein a portion of the light scattering centers are arranged in a different pattern that includes an irregular variation in spacing between adjacent light scattering centers.

Embodiment 32 is an ophthalmic lens of embodiment 28, wherein the light scattering centers are substantially circular in shape.

Embodiment 33 is an ophthalmic lens of embodiment 28, wherein the lens has a lens axis, and the aperture and annular region are substantially centered on the lens axis.

Embodiment 34 is an ophthalmic lens of embodiment 28, wherein the lens is an eyeglass lens or a contact lens.

Embodiment 35 is an ophthalmic lens, including: a lens body having two opposing surfaces; and an annular region surrounding a clear aperture, wherein the annular region has a plurality of spaced apart light scattering centers in the lens body and/or on at least one of the two opposing surfaces sized and shaped to scatter incident light, the light scattering centers being arranged in a pattern that includes a circumferential direction and a radial direction relative to the clear aperture, wherein the light scattering centers arranged along the radial direction have a uniform size, and the light scattering centers arranged along the circumferential direction have different sizes.

Embodiment 36 is an ophthalmic lens of embodiment 35, including a second annular region disposed between the clear aperture and the annular region, wherein the light scattering centers disposed in the second annular region are uniform in size in both the radial and circumferential directions.

Embodiment 37 is an ophthalmic lens of embodiment 28, wherein a portion of the light scattering centers are arranged in a different pattern that includes an irregular variation in spacing between adjacent light scattering centers.

Embodiment 38 is an ophthalmic lens, including: a lens body having two opposing surfaces; and an annular region surrounding a clear aperture, wherein the annular region has a plurality of spaced apart light scattering centers on at least one of the two opposing surfaces sized and shaped to scatter incident light, each light scattering center including a depression in the surface, wherein one or more of the light scattering centers has a depth profile with respect to the surface that comprises a first trench located towards a first sidewall of the depression and a second trench located towards a second sidewall of the depression.

Embodiment 39 is an ophthalmic lens of embodiment 38, wherein the depth profile of the depression is symmetrical about at least one plane.

Embodiment 40 is an ophthalmic lens of embodiment 38, wherein the depth profile of the depression is axially symmetric.

Embodiment 41 is an ophthalmic lens of embodiment 38, wherein a maximum depth of the first trench is substantially equal to a maximum depth of the second trench.

Embodiment 42 is an ophthalmic lens of embodiment 41, wherein an area between the first trench and the second trench of the one or more light scattering center has a different depth than the maximum depth of the first trench and the maximum depth of the second trench.

Embodiment 43 is an ophthalmic lens of embodiment 38, wherein an orientation of trenches in different ones of the light scattering centers varies at different locations of the annular region.

Embodiment 44 is an ophthalmic lens of any one of embodiments 38 through 43, wherein the one or more light scattering centers have a perimeter shape that is circular.

Embodiment 45 is an ophthalmic lens of any one of embodiments 38 through 44, wherein a maximum width of the light scattering centers is in a range from 100 micrometers (μm) to 1,500 μm.

Embodiment 46 is an ophthalmic lens of any one of embodiments 38 through 45, wherein a radial dimension of the first trench is 0.3 W or less, wherein W is a maximum width of the light scattering center.

Embodiment 47 is an ophthalmic lens of any one of embodiments 38 through 46, wherein the depth profile comprises one or more additional trenches between the first and second trenches.

Embodiment 48 is a method, including: exposing a first location of an ophthalmic lens of a lens material to a focused laser radiation of the laser beam to form a first sidewall of an optically scattering feature on a surface of the ophthalmic lens; causing relative motion between the laser beam and the lens in a first direction, away from the first sidewall, while exposing the lens to the focused laser radiation; and exposing a second location of the ophthalmic lens to the focused laser radiation to form a second sidewall of the optically scattering feature, wherein exposing the first location and the second location of the lens creates a depression in the lens material, the depression having a depth profile with respect to a surface of the ophthalmic lens that comprises a first trench located towards the first sidewall and a second trench located towards the second sidewall of the dot.

Embodiment 49 is a method of embodiment 48, wherein the exposing the first location comprises exposing the first location of the lens for a first time period, and wherein the exposing the second location comprises exposing the second location for a second time period greater than the first time period.

Embodiment 50 is a method of embodiment 48 or 49, wherein the first sidewall and the second sidewall form a round optically scattering feature.

Embodiment 51 is a method of any one of embodiments 48 through 50, wherein a depth of the first trench is substantially equal to a depth of the second trench.

Embodiment 52 is a method of any one of embodiments 48 through 51, wherein the causing relative motion creates an area between the first trench and the second trench of the one or more dots that has a different depth than the depth of the first trench and the depth of the second trench.

Embodiment 53 is an ophthalmic lens, including: a lens body having two opposing surfaces; and an annular region surrounding a clear aperture, wherein the annular region has a plurality of light scattering centers in the lens body and/or on at least one of the two opposing surfaces sized and shaped to scatter incident light, wherein a diameter of at least some of the plurality of scattering centers is in a range of approximately 1.001 mm to approximately 1.5 mm and a spacing between the dots varies across the annular region.

Embodiment 54 is an ophthalmic lens of embodiment 53, the light scattering centers being arranged in a pattern that includes a circumferential direction and a radial direction relative to the clear aperture, wherein the light scattering centers arranged along the radial direction have a uniform size, and the scattering centers arranged along the circumferential direction have a variable size.

Embodiment 55 is an ophthalmic lens of embodiment 53, including a second annular region disposed between the clear aperture and the annular region, wherein the light scattering centers disposed in the second annular region are uniform in size in both the radial and circumferential directions.

Embodiment 56 is an ophthalmic lens of embodiment 53, wherein a first light scattering center of the plurality of light scattering centers overlaps with an adjacent light scattering center.

Embodiment 57 is an ophthalmic lens of embodiment 56, wherein the light scattering centers are arranged in a pattern that includes rows, wherein the first light scattering center and the adjacent light scattering center are disposed in a row.

Embodiment 58 is an ophthalmic lens of embodiment 57, wherein the light scattering centers are arranged in a pattern that includes of columns.

Embodiment 59 is an ophthalmic lens of embodiment 53, wherein the light scattering centers are arranged in a pattern that includes an irregular variation in spacing between adjacent scattering centers.

Embodiment 60 is an ophthalmic lens of embodiment 53, wherein each light scattering center comprises a depression in one of the surfaces of the ophthalmic lens, wherein one or more of the light scattering centers has a depth profile with respect to the surface of the ophthalmic lens that comprises a first trench located towards a first sidewall of the light scattering center and a second trench located towards a second sidewall of the light scattering center.

Embodiment 61 is an ophthalmic lens of embodiment 60, wherein the depth profile of the one or more light scattering centers is symmetrical.

Embodiment 62 is an ophthalmic lens of embodiment 60, wherein a depth of the first trench is substantially equal to a depth of the second trench.

While this specification contains many specific implementation details, these should not be construed as limitations on the scope of any disclosure or of what may be claimed, but rather as descriptions of features that may be specific to particular examples of particular disclosures. Certain features that are described in this specification in the context of separate examples can also be implemented in combination in a single example. Conversely, various features that are described in the context of a single example can also be implemented in multiple examples separately or in any suitable subcombination. Moreover, although features may be described herein as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the examples described herein should not be understood as requiring such separation in all examples, and it should be understood that the described program components and systems can generally be integrated together in a single product or packaged into multiple products.

Particular examples of the subject matter have been described. Other examples are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. An ophthalmic lens, comprising:
a lens body having a pair of opposing curved surfaces; and
a plurality of discrete light scattering centers arranged in an area of at least one of the opposing curved surfaces, each scattering center having a shape defined, at least in part, by a perimeter shape, a maximum depth, D, and a maximum width, W,
wherein a ratio D/W is ⅕ or less.

2. The ophthalmic lens of claim 1,
wherein D is of 30 micrometers (μm) or less and W is 50 μm or more.

3. The ophthalmic lens of claim 1,
each scattering center comprising a depression having a floor having a minimum width, W_{floor}, and a maximum depth variation, δD_{floor},
wherein W_{floor} is 0.5 W or more and the δD_{floor} is 0.2 D or less.

4. The ophthalmic lens of claim 1,
wherein the perimeter shape is selected from the group consisting of a star, a regular polygon, a dumbbell, a pear shape, a parallelogram, a crescent, a cone, and a zigzag.

5. The ophthalmic lens of claim 1,
wherein, a density of the plurality of light scattering centers in the area and a shape of the plurality of light scattering centers are selected so that, for light incident on the area of the ophthalmic lens propagating parallel to a lens axis, the ophthalmic lens backscatters 12% or less of the light incident on the area.

6. The ophthalmic lens of claim 1, wherein the area surrounds a clear area devoid of scattering centers.

7. The ophthalmic lens of claim 1, wherein the area is an annular area.

8. The ophthalmic lens of claim 1, wherein the plurality of light scattering centers are formed on a single surface of the ophthalmic lens.

9. The ophthalmic lens of claim 1, wherein the plurality of light scattering centers are formed only on a single surface of the ophthalmic lens.

10. The ophthalmic lens of claim 9, wherein the single surface if a concave surface.

11. The ophthalmic lens of claim 9, wherein the single surface if a convex surface.

12. The ophthalmic lens of claim 1, wherein each of the plurality of light scattering centers has the same shape.

13. The ophthalmic lens claim 1, wherein at least some of the plurality of light scattering centers have different shapes.

14. The ophthalmic lens of claim 1, wherein the ophthalmic lens is a spectacle lens or a contact lens.

15. The ophthalmic lens of claim 1, wherein the ophthalmic lens is a plano lens, a single vision lens, or a multifocal lens.

16. (canceled)

17. A method, comprising:
exposing a surface of an ophthalmic lens to one or more pulses of laser radiation sufficient to create a light scattering center in the surface; and
moving the laser radiation relative to the surface while exposing the surface to trace a path on the surface,
wherein the light scattering center has a maximum width, W, in a range from 50 micrometers to 1,000 micrometers and a perimeter shape selected from the group consisting of a star, a regular polygon, a dumbbell, a pear shape, a parallelogram, a crescent, a cone, and a zigzag.

18-62. (canceled)
